(19) United States
(12) Patent Application Publication
(10) Pub. No.: US 2015/0223498 A1
(43) Pub. Date: Aug. 13, 2015

(54) EMULSIFYING AGENT FOR USE IN FOOD COMPOSITIONS

(71) Applicant: Solae, LLC, St. Louis, MO (US)

(72) Inventors: Yeun S. Gu, St. Louis, MO (US); Zebin Wang, St. Louis, MO (US); William C. Smith, St. Louis, MO (US); John A. Brown, St. Louis, MO (US)

(21) Appl. No.: 14/417,356

(22) PCT Filed: Jul. 26, 2013
(86) PCT No.: PCT/US2013/052386

§ 371 Date: Jan. 26, 2015

Related U.S. Application Data
(60) Provisional application No. 61/675,941, filed on Jul. 26, 2012.

(51) Int. Cl. A23L 1/035; A23J 1/14

(52) U.S. Cl. CPC A23L 1/035; A23J 1/14; A23V 2002/00; A23L 1/39

(57) ABSTRACT

An emulsifying agent comprising an amount of soy whey protein is disclosed herein, the soy whey protein having been isolated from processing streams. The emulsifying agent is especially suitable for producing a food product.

This application claims priority from U.S. Provisional Application Ser. No. 61/675,941 filed on Jul. 26, 2012, which is hereby incorporated by reference in its entirety.

### FIELD OF THE INVENTION

The present disclosure relates to an emulsifying agent for use in food products. Specifically, the emulsifying agent comprises an amount of soy whey protein having a soluble solids index (SSI) of at least about 80% across a pH range of from 2 to 10 and a temperature of 25° C.

### BACKGROUND OF THE INVENTION

Food scientists in the industry continually work to develop novel processes and resulting products that deliver improved nutritional and functional characteristics that consumers desire. The inclusion of soy protein is a cost-effective way to reduce fat, increase protein content and improve overall sensory characteristics of many food products.

In preparing food products it is often necessary to mix two immiscible substances, such as oil and water. It is known that immiscible liquids or substances do not mix and will separate into different layers often giving the food a bad appearance and a gritty taste. To prevent the substances from separating out into different layers, emulsifiers are routinely added to form an emulsion.

Emulsifiers are used to facilitate the formation of small emulsion droplets between the oil and water in the mix by coating the surface of droplets in an emulsion and insulating the oil or water droplets from the water or oil phase. When the oil or water droplets are insulated, they are able to be evenly dispersed throughout the emulsion and are prevented from clumping together to form a separate layer that floats above the water layer or sedimentation under the oil layer. Compounds typically used in the art as emulsifiers are low molecular weight compounds, normally less than about 10 kilodaltons (kDa). Smaller compounds are often used as emulsifiers because they have a high surface activity and are able to lower the interfacial tension of water better and more rapidly than high molecular weight compounds. However, small molecules are not usually able to provide long-term stability of the emulsion and additional components, such as stabilizers, must be added to prevent the emulsion from separating.

High molecular weight compounds, such as proteins other than soy whey protein and carbohydrates, are also used as emulsifiers. However, high molecular weight compounds typically perform better as stabilizers than as emulsifiers since the larger molecules exhibit low interfacial activity.

Emulsifiers are routinely added to various food products to encourage the suspension of oil-in-water or water-in-oil. Examples of commonly known emulsifiers typically used in the art include, but are not limited to, mono- and diglycerides of fatty acids, esters of monoglycerides of fatty acids, diacetyl tartaric acid ester of mono- and diglycerides (DATEM), propylene glycol monoesters, lecithin, hydroxylated lecithin, dioctyl sodium sulphosuccinate, sodium stearoyl-2-lactylate (SSL), calcium stearoyl lactylate (CSL), sorbitan monolaurate (Polysorbate 20 or Tween20), sorbitan monopalmitate (Polysorbate 40 or Tween40), sorbitan monostearate (Polysorbate 60 or Tween60), sorbitan monooleate (Polysorbate 80 or Tween80), sorbitan tristearate, stearyl citrate, polyglycerol polyricinoleate (PGPR), and caseinate. These commonly used emulsifiers are known to produce the desired characteristics of a food product. However, while caseinate is a protein that has been shown to have emulsifying properties, it has solubility issues within a pH range of 3.0-5.0 which keeps it from working as an emulsifier in this pH range which covers acidic food products. It would be desirable to use protein-based emulsifiers, especially if such emulsifiers are plant-based in conjunction with or as a replacement for commonly used emulsifiers in order to provide nutritional and functional benefits to food products. It would also be desirable if such protein-based emulsifiers could work across a broad pH range (2.0-10.0).

An ideal emulsifier would be one that has a high interfacial activity to form an emulsion but also provides long-term emulsion stability. Small molecular weight surfactants have high surface activity, thereby producing small droplets, but fail to provide long-term emulsion stability. High molecular weight biopolymers, such as proteins and carbohydrates, have low interfacial activity, thereby producing large droplets, but they can provide long-term emulsion stability due to a formation of thick membrane surrounding droplets.

Thus, there is a need in the art for a food-grade emulsifying agent that contains a protein-based substance and that provides long-term emulsion stability. The emulsifying agent can further impart to food products an amount of protein and overall nutritional profile desired by a consumer. Accordingly, the present invention is directed to an emulsifying agent comprised in whole or in part of soy whey protein for use in a food product, thereby eliminating or reducing the need to add an additional emulsifier to the food product.

### SUMMARY OF THE INVENTION

The present disclosure relates to an emulsifying agent for use in food products. Specifically, the emulsifying agent comprises an amount of soy whey protein having a SSI of at least about 80% across a pH range of from 2 to 10 and a temperature of 25° C. The inclusion of soy whey protein as an emulsifier acts to provide long-term emulsion stability for the food products and produces a food product having sensory properties (i.e., taste, structure, aroma and mouthfeel) desired by consumers when compared to similar food products currently on the market containing known emulsifiers.

The present disclosure further relates to food products that contain an emulsifying agent comprising an amount of soy whey protein having a SSI of at least about 80% across a pH range of from 2 to 10 and a temperature of 25° C. The emulsifying agent disclosed herein is suitable for use in the preparation of various types of food products comprising immiscible substances, such as, for example, whipped toppings, salad dressings, spreadable oils (including margarines having an oil concentration range of 10-80%), mayonnaises, baked dessert products (such as cakes), confections (such as nougats, meringues, etc.), frozen confections and frozen desserts (such as, ice creams, etc.), puddings, chocolate, meats, cheese sauces, beverages (including alcoholic beverages), soups, fondant, coffee creamers (liquid or dry), fat powders, and the like.

The present disclosure further relates to a method of making a food product, the method comprising combining an emulsifying agent with at least two immiscible substances to form an emulsion and processing the emulsion into the desired food product, wherein the emulsifying agent comprises an amount of soy whey protein having a SSI of at least about 80% across a pH range of from 2 to 10 and a temperature of 25° C.

### REFERENCE TO COLOR FIGURES

The application contains at least one photograph executed in color. Copies of this patent application publication with color photographs will be provided by the Office upon request and payment of the necessary fee.

### BRIEF DESCRIPTION OF THE DRAWINGS

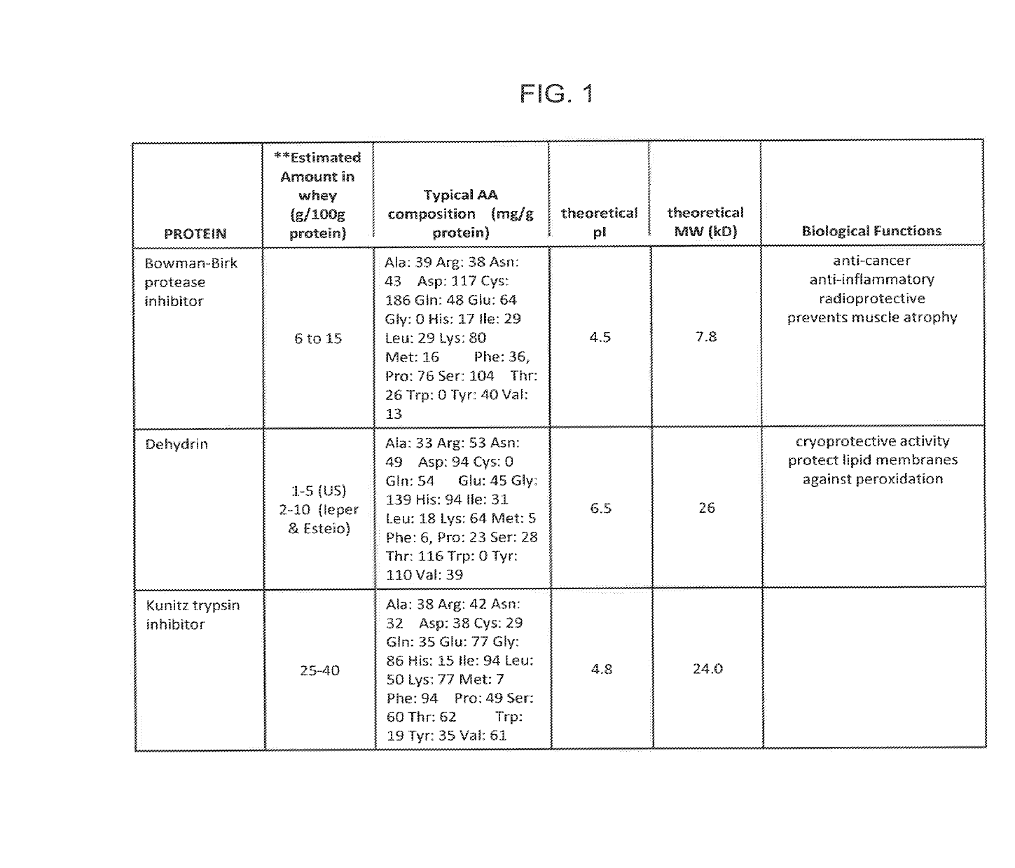

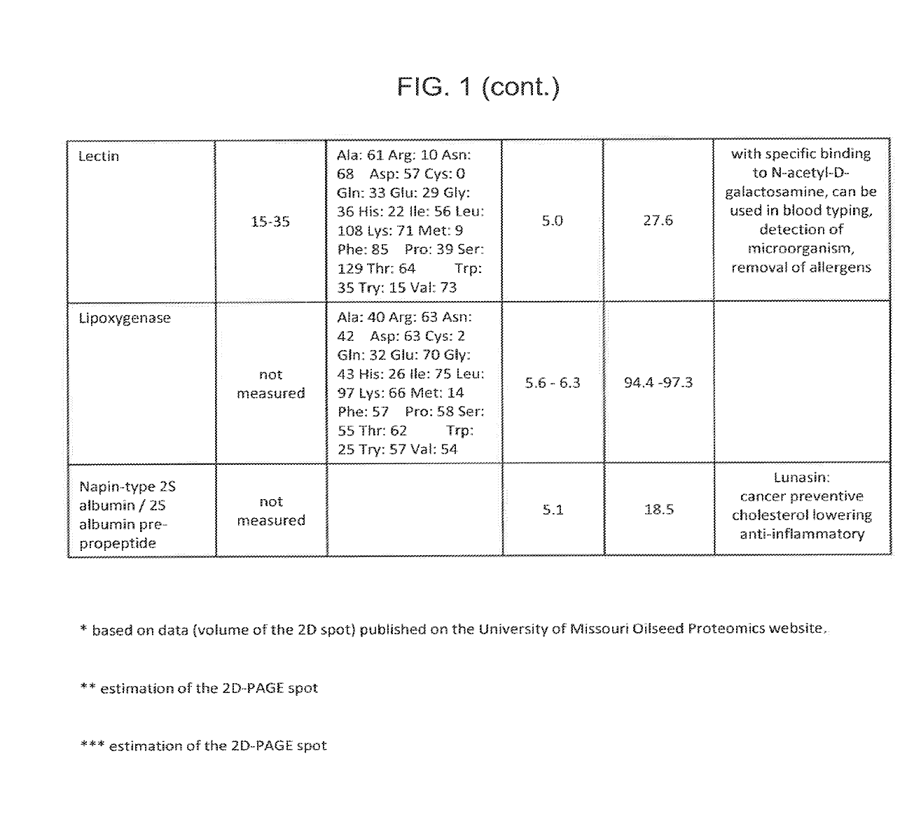

FIG. 1 is a chart setting forth the proteins found in soy whey streams and their characteristics.

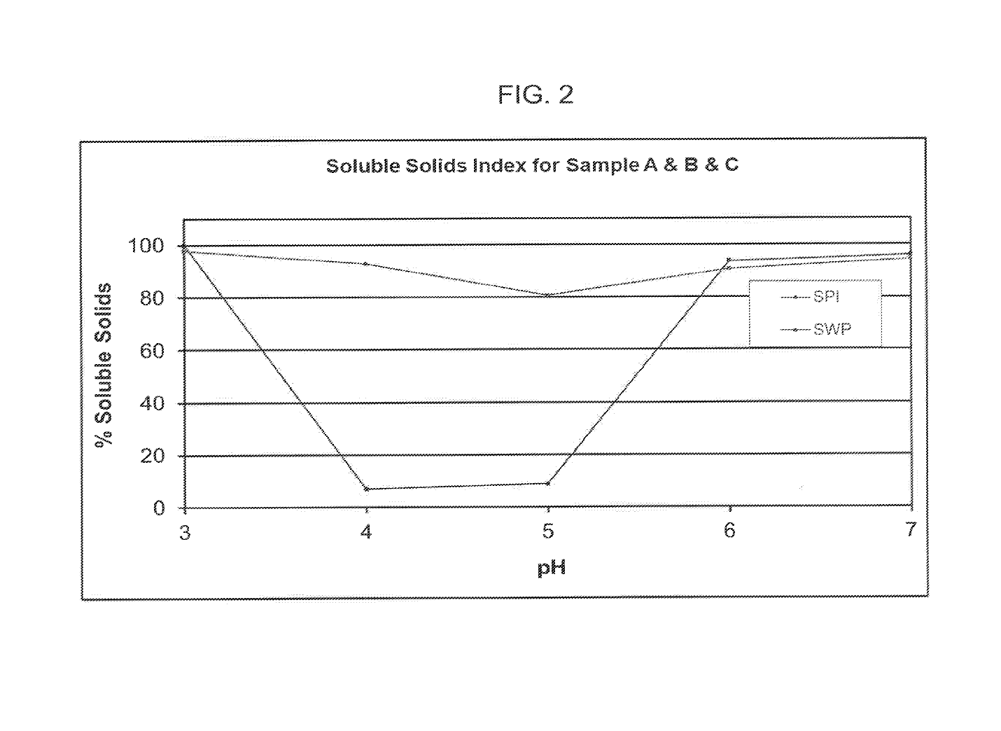

FIG. 2 graphically depicts the solubility of the soy whey proteins over a pH range of 3-7 as compared to that of soy protein isolates.

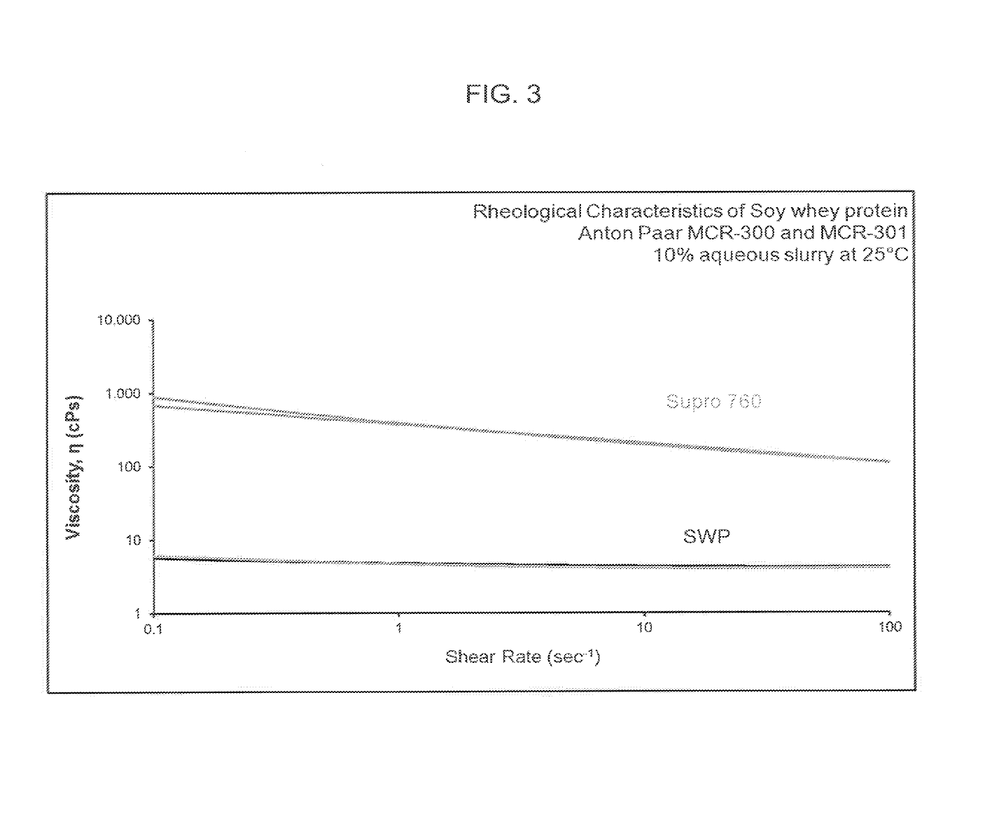

FIG. 3 graphically depicts the rheological properties of the soy whey proteins compared to soy protein isolate, Supro® 760.

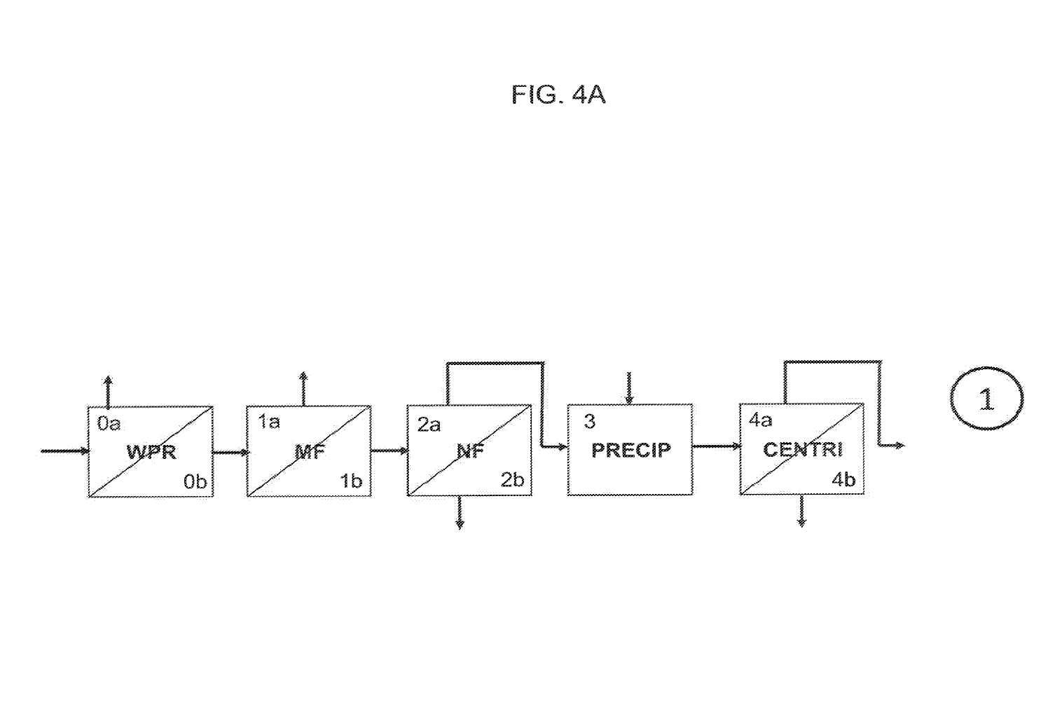

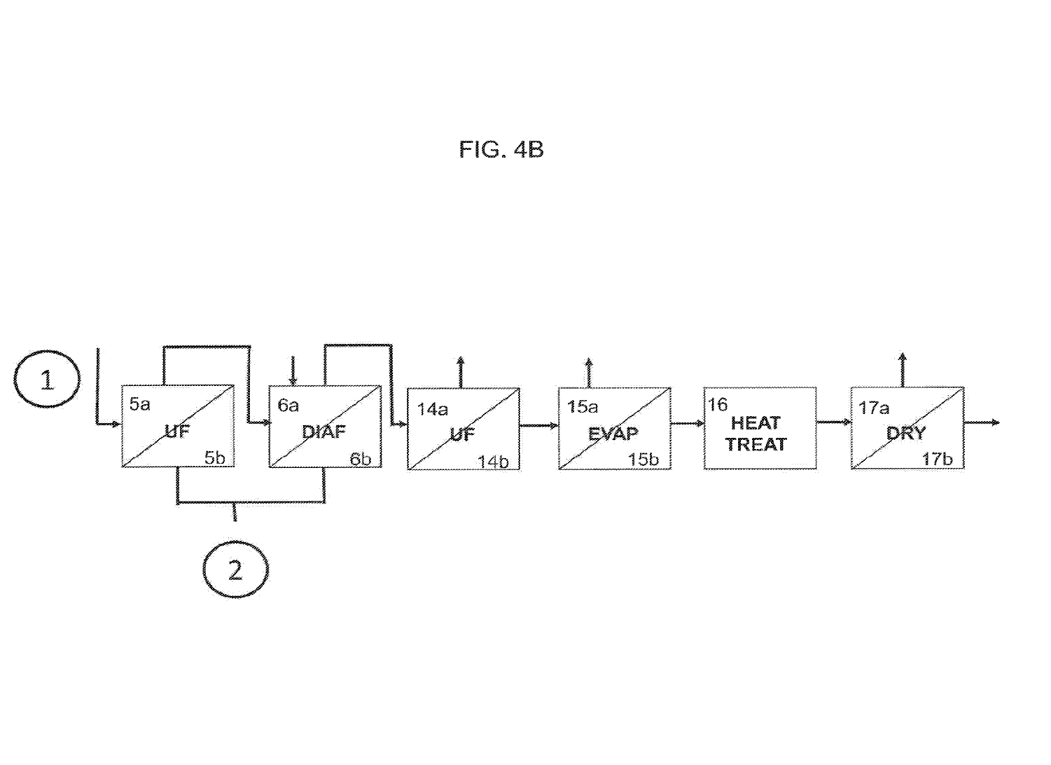

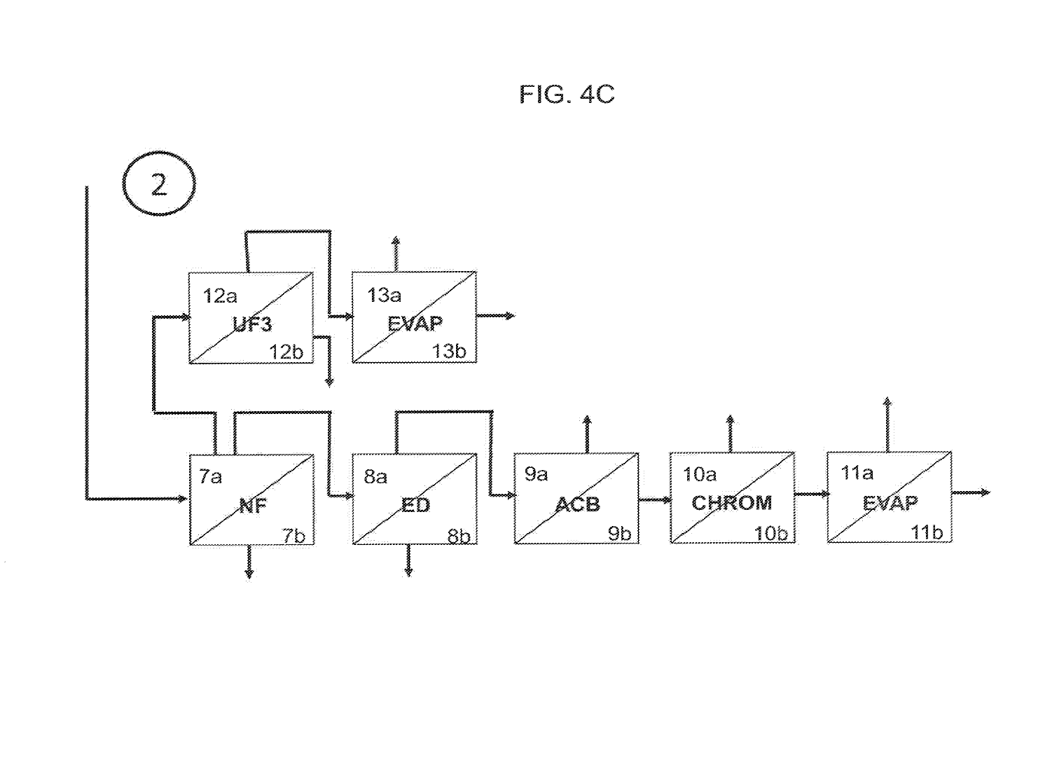

FIG. 4A is a schematic flow sheet depicting Steps 0 through 4 in a process for recovery of a purified soy whey protein from processing stream.

FIG. 4B is a schematic flow sheet depicting Steps 5, 6, 14, 15, 16, and 17 in a process for recovery of a purified soy whey protein from processing stream.

FIG. 4C is a schematic flow sheet depicting Steps 7 through 13 in a process for recovery of a purified soy whey protein from processing stream.

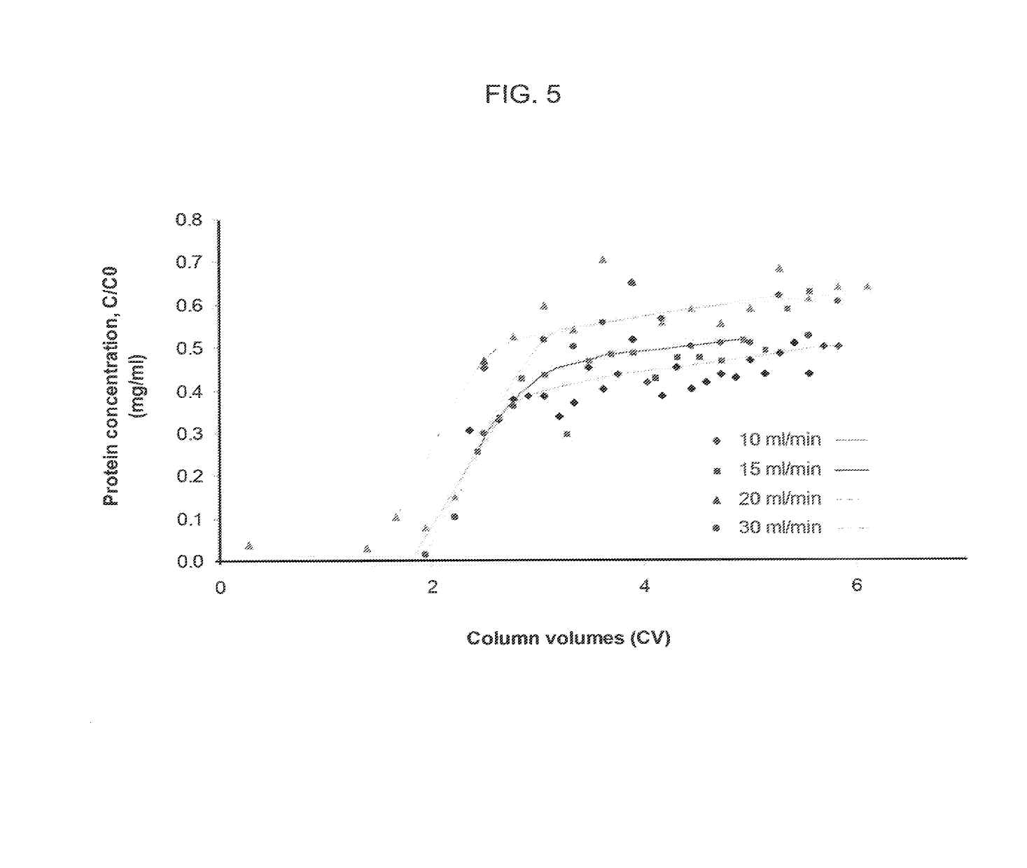

FIG. 5 graphically illustrates the breakthrough curve when loading soy whey at 10, 15, 20 and 30 mL/min (5.7, 8.5, 11.3, 17.0 cm/min linear flow rate, respectively) through a SP Gibco cation exchange resin bed plotted against empty column volumes loaded.

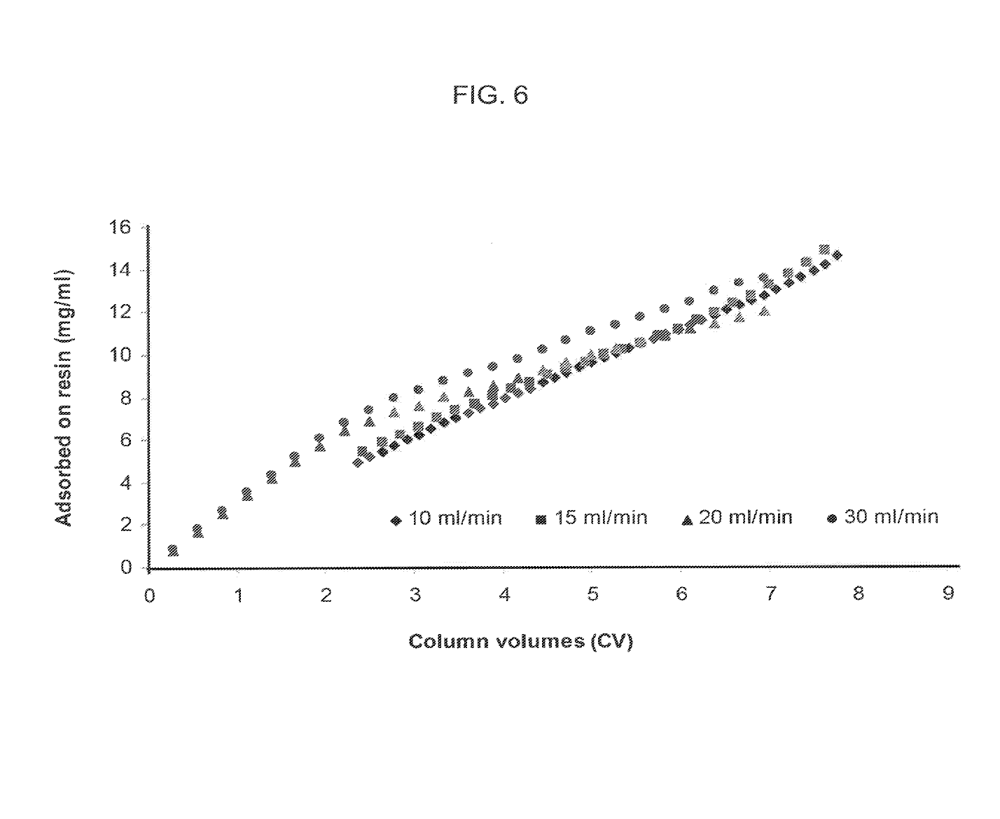

FIG. 6 graphically illustrates protein adsorption on SP Gibco cation exchange resin when passing soy whey at 10, 15, 20 and 30 mL/min (5.7, 8.5, 11.3, 17.0 cm/min linear flow rate, respectively) plotted against empty column volumes loaded.

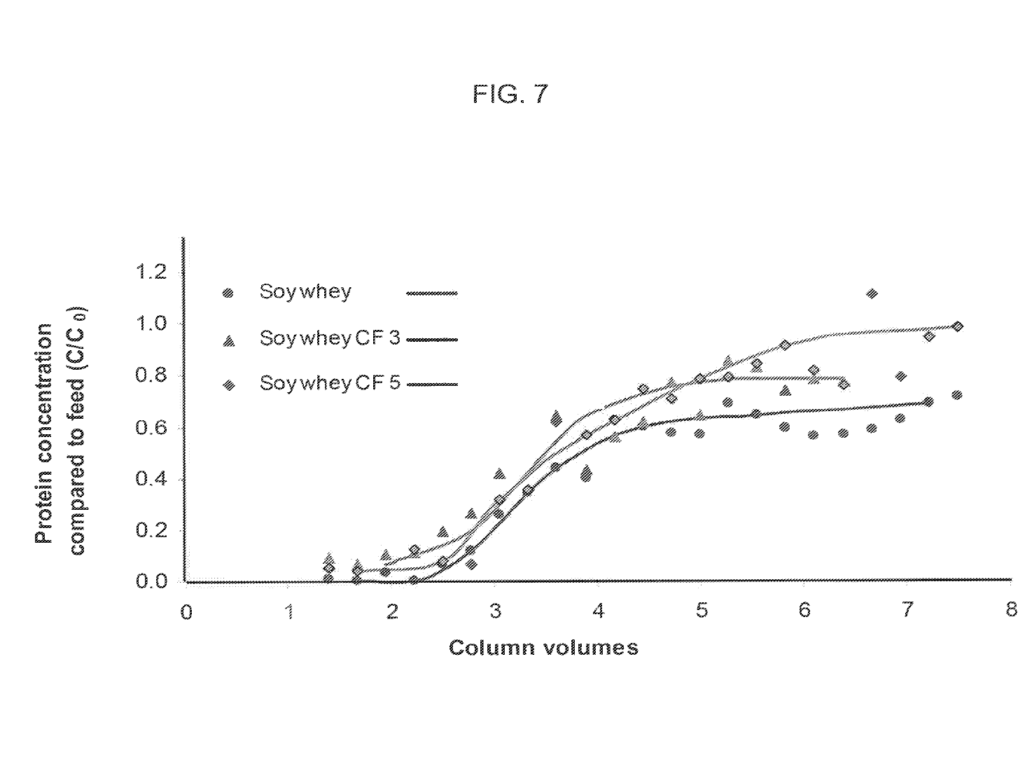

FIG. 7 graphically illustrates the breakthrough curve when loading soy whey at 15 mL/min and soy whey concentrated by a factor of 3 and 5 through SP Gibco cation exchange resin bed plotted against empty column volumes loaded.

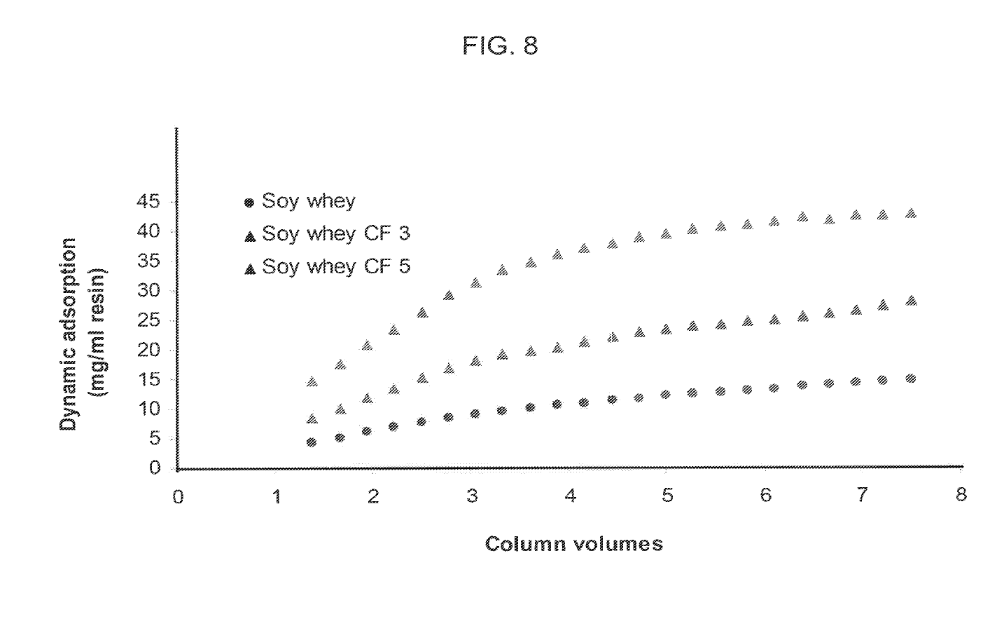

FIG. 8 graphically illustrates protein adsorption on SP Gibco cation exchange resin when passing soy whey and soy whey concentrated by a factor of 3 and 5 at 15 mL/min through SP Gibco cation exchange resin bed plotted against empty column volumes loaded.

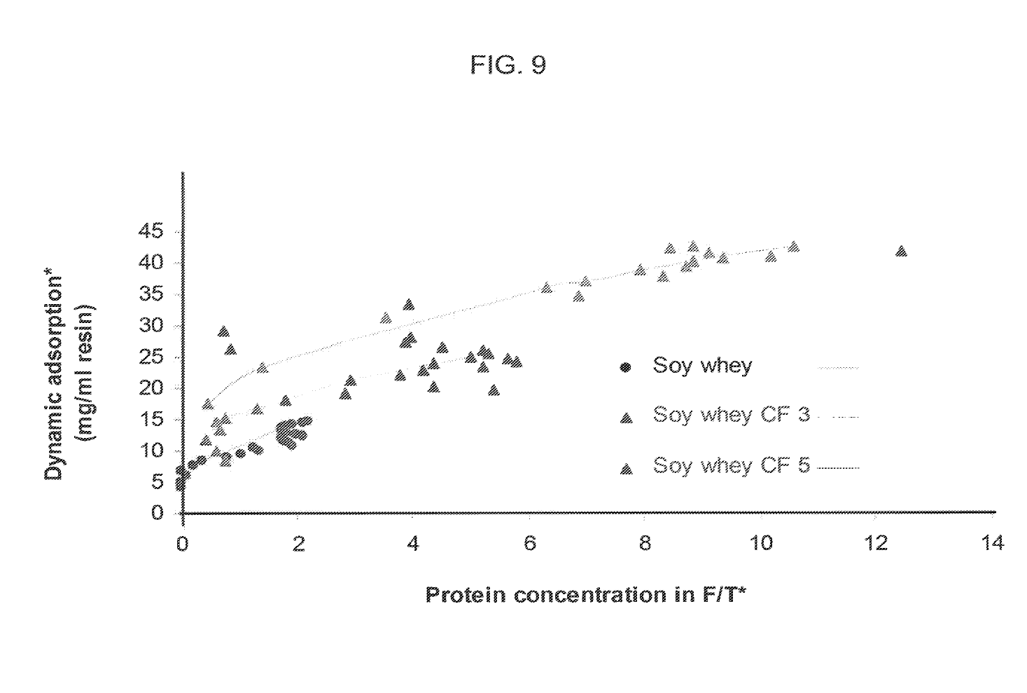

FIG. 9 graphically depicts equilibrium protein adsorption on SP Gibco cation exchange resin when passing soy whey and soy whey concentrated by a factor of 3 and 5 at 15 mL/min through SP Gibco cation exchange resin bed plotted against equilibrium protein concentration in the flow through.

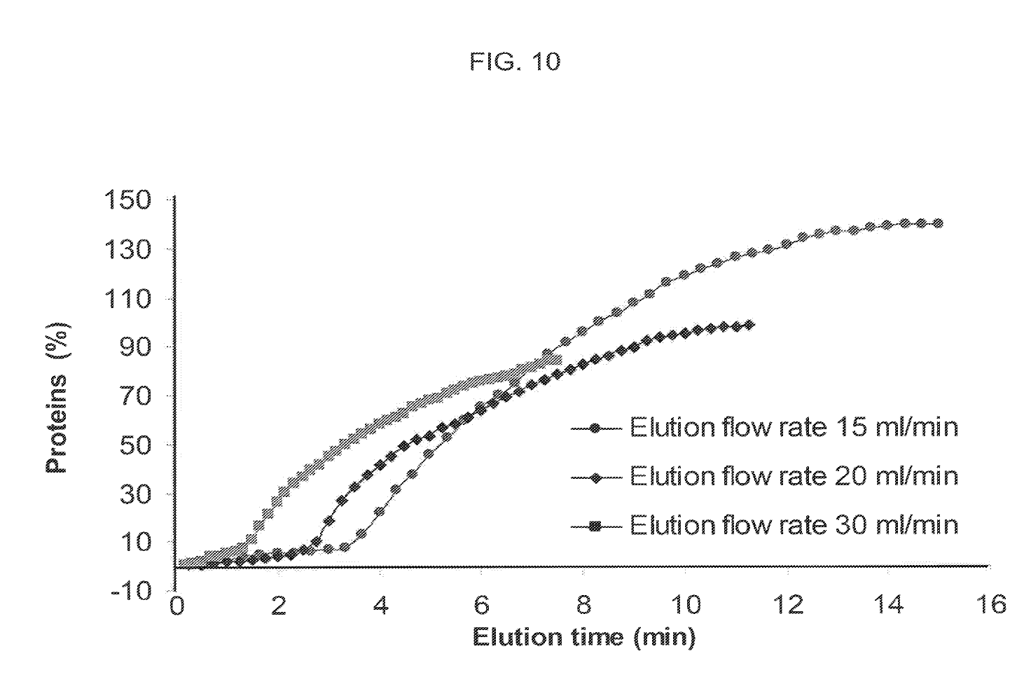

FIG. 10 graphically illustrates the elution profiles of soy whey proteins desorbed with varying linear velocities over time.

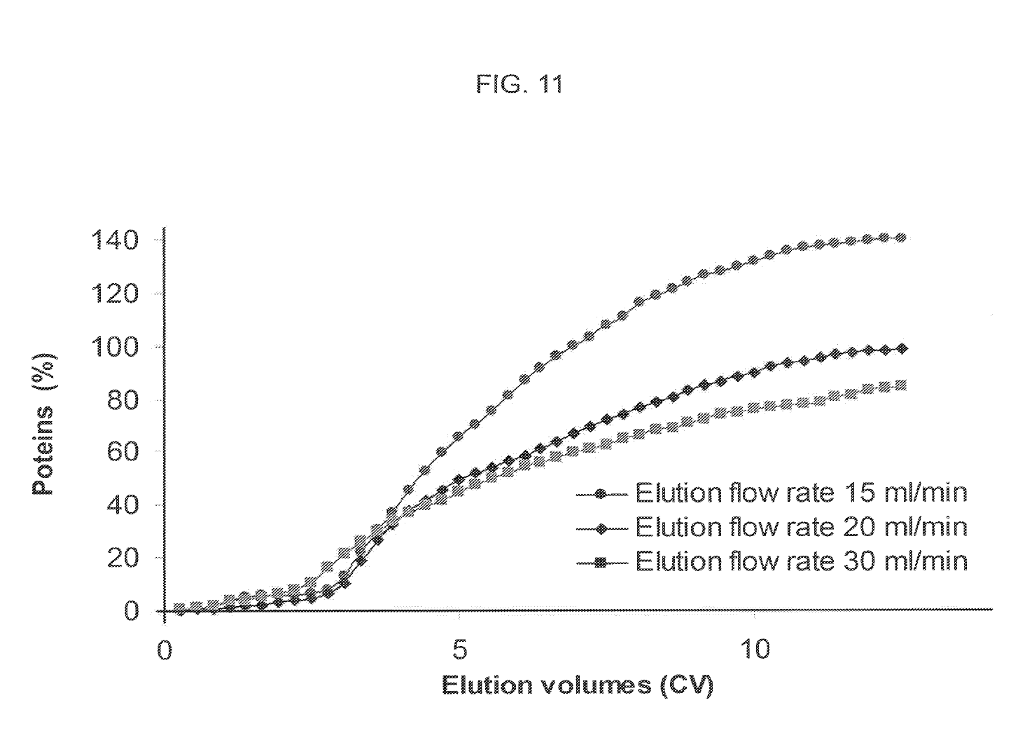

FIG. 11 graphically illustrates the elution profiles of soy whey proteins desorbed with varying linear velocities with column volumes.

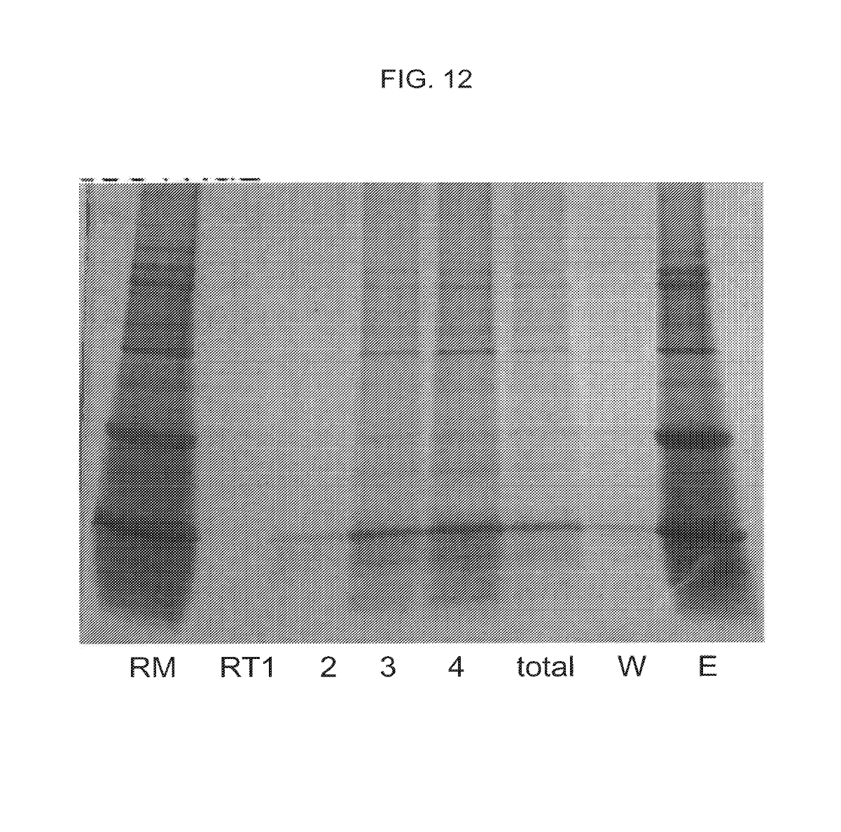

FIG. 12 depicts a sodium dodecyl sulfate polyacrylamide gel electrophoresis (SDS-PAGE) analysis of Mimo6ME fractions.

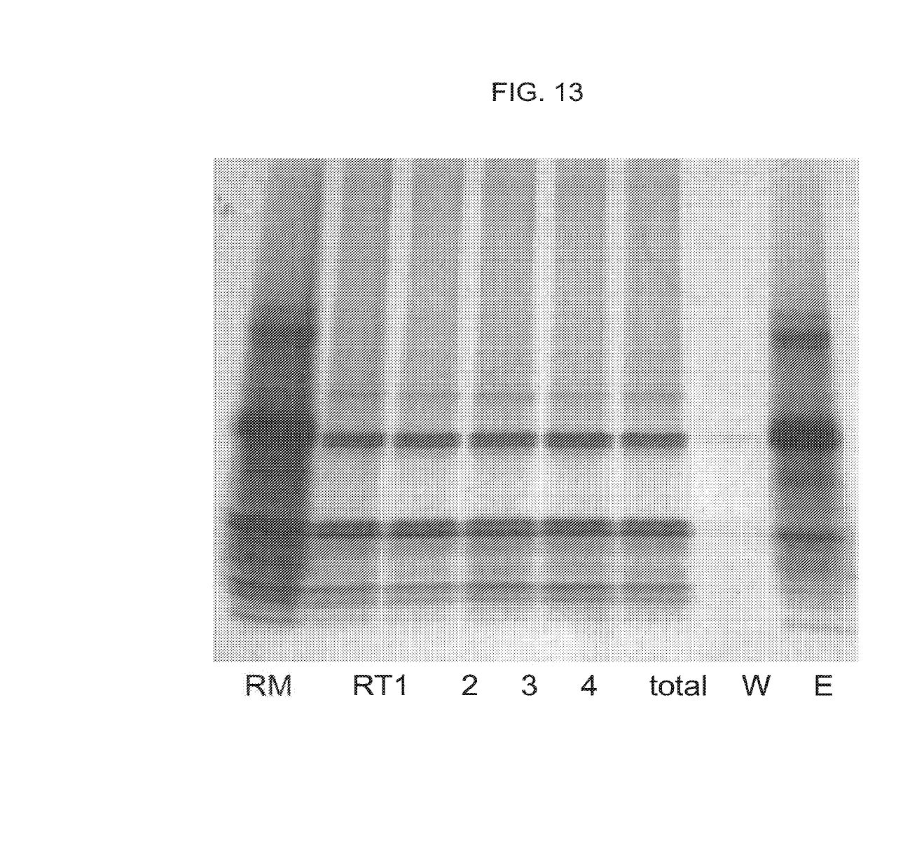

FIG. 13 depicts a SDS-PAGE analysis of Mimo4SE fractions.

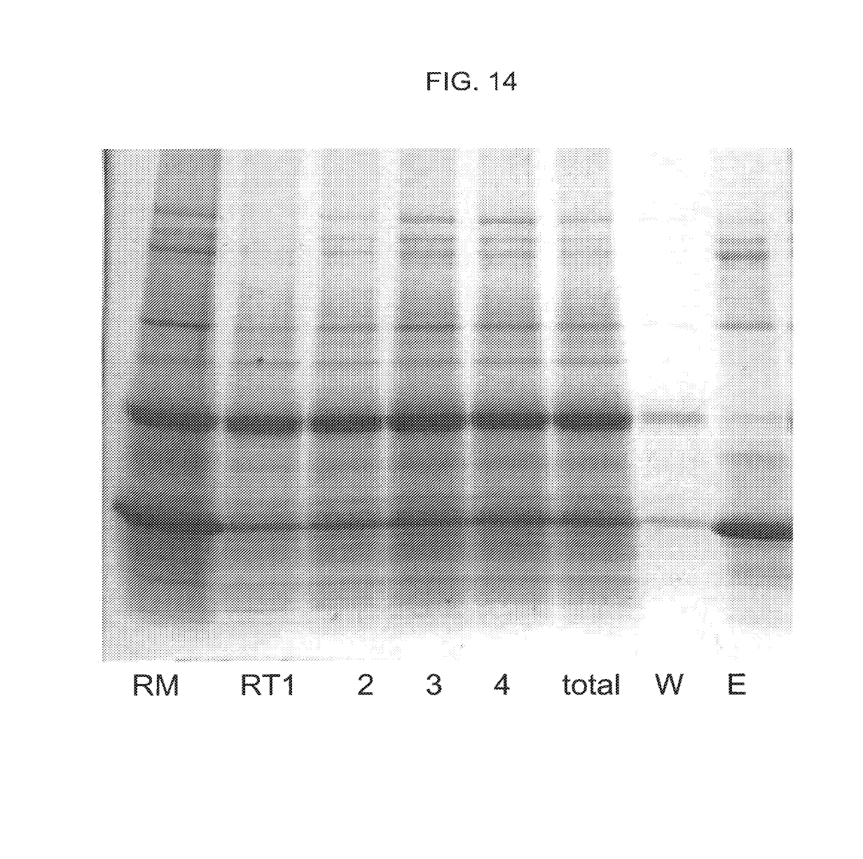

FIG. 14 depicts a SDS-PAGE analysis of Mimo6HE fractions.

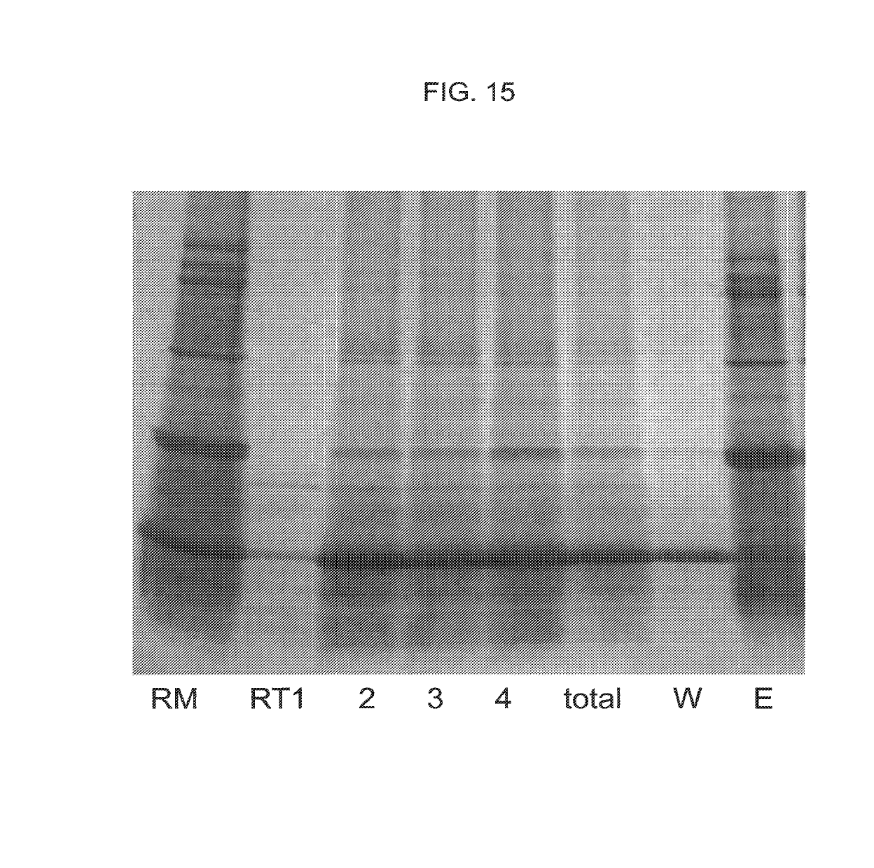

FIG. 15 depicts a SDS-PAGE analysis of Mimo6ZE fractions.

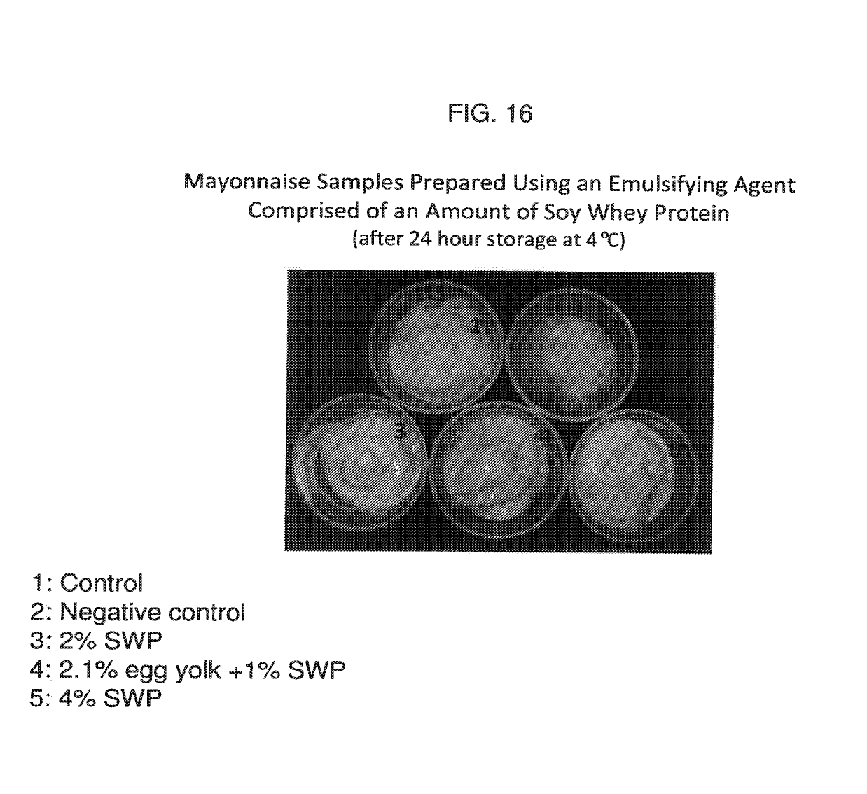

FIG. 16 is a photograph of mayonnaise samples prepared using an emulsifying agent Comprised of an amount of soy whey protein (after 24 hour storage at 4° C.); 1: Control; 2: Negative Control; 3: 2% soy whey protein; 4: 2.1% egg yolk plus 1% soy whey protein; and, 5: 4% soy whey protein.

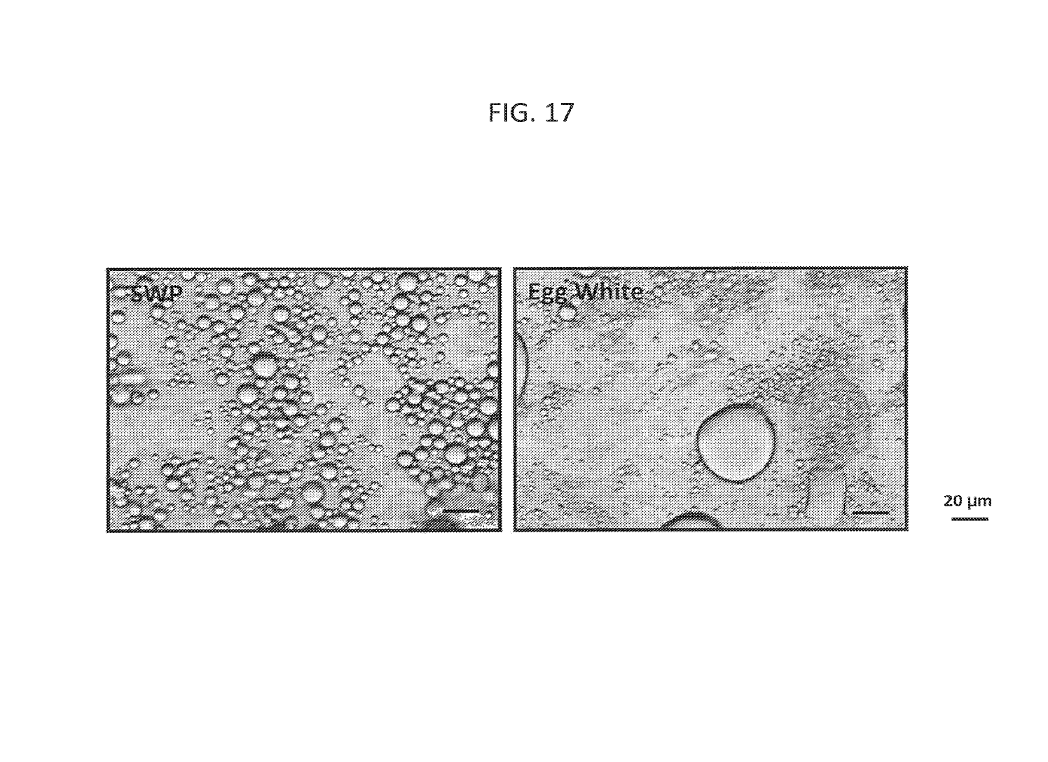

FIG. 17 are digital microscopy images of diluted mayonnaise (10% oil-in-water (o/w) emulsion) prepared with SWP and egg yolk. Images using Olympus BX50 with Nikon D80 digital microscope at 1000× magnification.

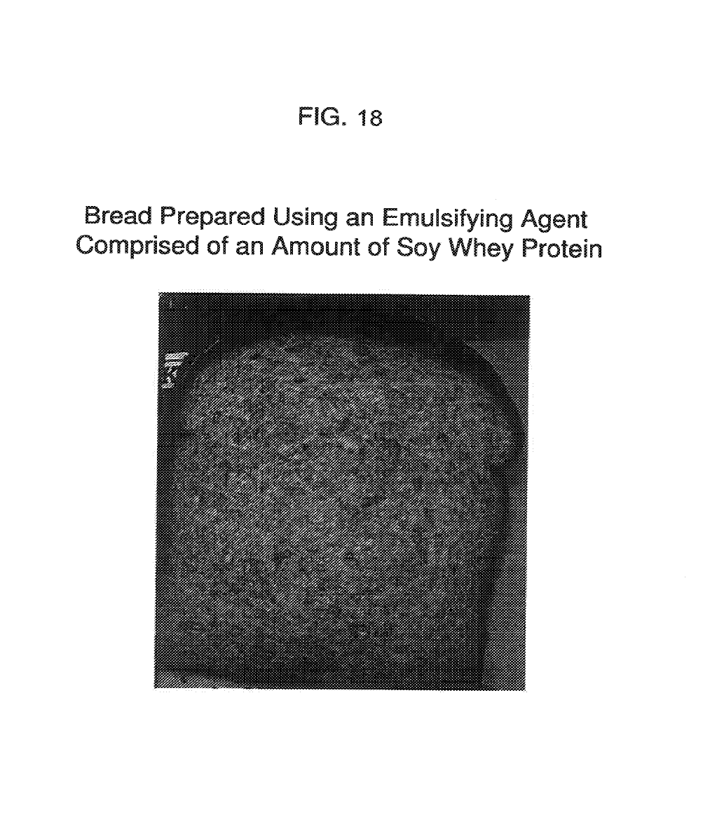

FIG. 18 is a photograph of a bread sample prepared using an emulsifying agent comprised of an amount of soy whey protein.

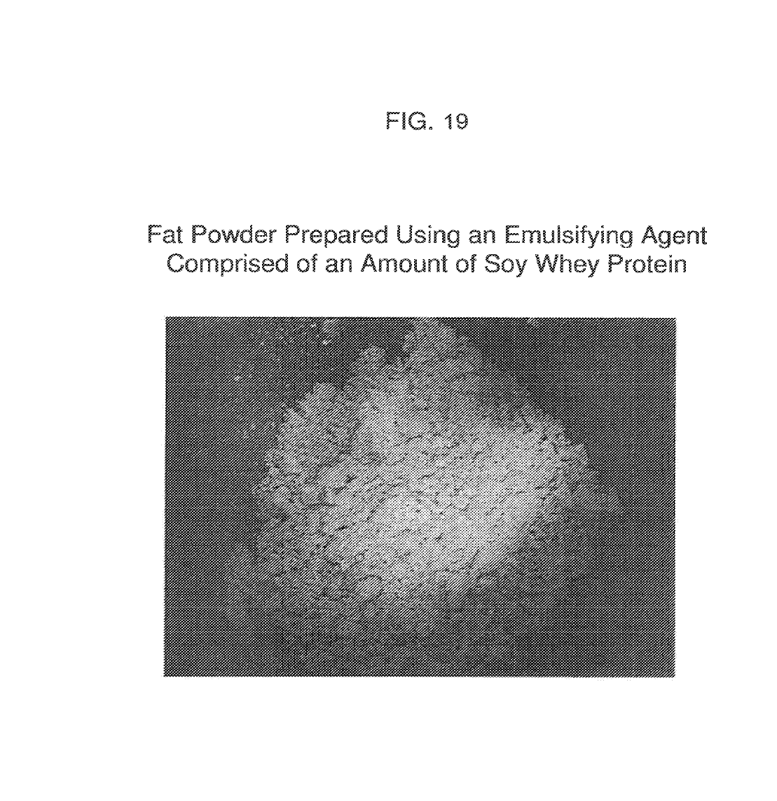

FIG. 19 is a photograph of a fat powder prepared using an emulsifying agent comprised of an amount of soy whey protein.

### DETAILED DESCRIPTION OF THE PREFERRED ASPECTS

The present invention provides an emulsifying agent comprising an amount of soy whey protein having a SSI of at least about 80% across a pH range of from 2 to 10 and a temperature of 25° C. The emulsifying agent, when added to food products, imparts an improved nutritional and functional profile, (e.g., increased amount of protein) and sensory properties (i.e., taste, structure, aroma, and mouthfeel) desired by consumers when comparing the resultant products to similar food products currently on the market which contain commonly used emulsifiers.

### I. Emulsifying Agent

The emulsifying agent of the present invention for use in food products contains an amount of soy whey protein having a SSI of at least about 80% across a pH range of from 2 to 10 and a temperature of 25° C.

The soy whey proteins of the present invention have been discovered to impart superior emulsification properties when used in emulsions over known emulsifiers currently used in the art. The soy whey proteins of the present invention are effective emulsifying agents in a broad pH range of 2.0-10.0. Thus, the emulsifying agent of the present invention is a good emulsifier for use in acidic food products. It has been surprisingly discovered that while soy whey proteins are high molecular weight compounds (e.g., about 8 kDa to about 50 kDa), they possess the desired characteristics of both small molecular weight emulsifiers and large molecular weight emulsifiers. Specifically, it is believed that because the soy whey proteins have a higher molecular weight they are able to provide long-term stability of emulsions but surprisingly behave as small molecular weight emulsifiers in that they promote rapid reduction in surface tension.

In one embodiment, the emulsifying agent of the present invention contains 100% soy whey protein. In another embodiment, the emulsifying agent contains a combination of soy whey protein and at least one additional emulsifier. For instance, the emulsifying agent may comprise soy whey protein and at least one additional emulsifier selected from the group consisting of mono- and diglycerides of fatty acids, esters of monoglycerides of fatty acids, DATEM, propylene glycol monoesters, lecithin, hydroxylated lecithin, dioctyl sodium sulphosuccinate, SSL, CSL, Polysorbate 20, Polysorbate 40, Polysorbate 60, Polysorbate 80, sorbitan tristearate, stearyl citrate, PGPR, caseinate and combinations thereof. For example, the emulsifying agent may contain between about 5% to about 99.9% (w/w) of soy whey protein. Specifically, the emulsifying agent of the present invention may contain about 5%, 10%, 15%, 20%, 25%, 30%, 35%, 40%, 45%, 50%, 55%, 60%, 65%, 70%, 75%, 80%, 85%, 90%, 95%, 96%, 97%, 98%, 98.5%, 99%, 99.5%, 99.6%, 99.7%, 99.8%, or 99.9% (w/w) of soy whey protein for use in a food product. In one embodiment the emulsifying agent may contain soy whey protein and DATEM. In an additional embodiment, the emulsifying agent of the present invention may further act as a stabilizing agent.

### II. Soy Whey Proteins

The soy whey proteins of the present disclosure represent a significant advance in the art over other soy proteins and isolates. As noted herein, the soy whey proteins of the present disclosure possess unique characteristics as compared to other soy proteins found in the art.

Soy protein isolates are typically precipitated from an aqueous extract of defatted soy flakes or soy flour at the isoelectric point of soy storage proteins (e.g. a pH of about 4.5±0.5). Thus, soy protein isolates generally include proteins that are not soluble in acidic liquid media. Similarly, the proteins of soy protein concentrates, the second-most refined soy protein material, are likewise generally not soluble in acidic liquid media. However, soy whey proteins of the present disclosure differ in that they are generally acid-soluble, meaning they are soluble in acidic liquid media.

The present disclosure provides soy whey protein compositions derived from an aqueous soy whey that exhibit advantageous characteristics over soy proteins found in the prior art.

A. High Solubility

The soy whey proteins isolated according to the methods of the present invention possess high solubility (i.e. SSI % greater than 80) across a relatively wide pH range of the aqueous (typically acidic) medium (e.g. an aqueous medium having a pH of from about 2 to about 10, from about 2 to about 7, or from about 2 to about 6) at ambient conditions (e.g. a temperature of about 25° C.). As shown in Table 1 and graphically illustrated in FIG. 2, the solubility of the soy whey proteins isolated in accordance with the methods of the present disclosure, at all pH values tested, was at least 80%, and in all but one instance (i.e. pH 4) was at least about 90%. These findings were compared with soy protein isolate, which was shown to display poor solubility characteristics at the same acid pH values. This unique characteristic enables the soy whey proteins of the present invention to be used in applications having acidic pH levels, which represents a significant advantage over soy isolate.

B. Low Viscosity

In addition to solubility, the soy whey proteins of the present disclosure also possess much lower viscosity than other soy proteins. As shown in Table 1 and as graphically illustrated in FIG. 3, the soy whey proteins of the present invention displayed viscoelastic properties (i.e. rheological properties) more similar to that of water than shown by soy protein isolate. The viscosity of water is about 1 centipoise (cP) at 20° C. The soy whey proteins of the present disclosure were found to exhibit viscosity within the range of from about 2.0 to 10.0 cP, and preferably from about 3.6 to 7.5 cP. This low viscosity, in addition to its high solubility at acidic pH levels, makes the soy whey protein of the present disclosure available and better suited for use in certain applications that regularly involve the use of other soy proteins (e.g., in food products), because it has much better flow characteristics than that of soy isolate.

TABLE 1
Solubility and Viscoelastic Properties of Soy Whey
Compared to a Commercial Isolated Soy Protein

| | SWP | Supro ® 500E |
|---|---|---|
| SSI %, pH 3.0 | 99 | 100 |
| SSI %, pH 4.0 | 82.3 | 7 |
| SSI %, pH 5.0 | 89.4 | 9 |
| SSI %, pH 6.0 | 99.3 | 94 |
| SSI %, pH 7.0 | 99.4 | 96 |
| Viscosity*, cPs | 4.3 | 5700-7100 |

*Viscosity was measured on isolate in water slurries at as is pH. Concentration at 10% w/w (weight isolate/total sample weight). Temperature at 25° C. Shear rate was 1 1/s (second).

As Table 2 illustrates, the other physical characteristics, with the exception of the viscoelastic properties and solubility, of the soy whey protein recovered in accordance with the methods of the present disclosure were found to be very similar to that of soy isolate.

TABLE 2
Physical Characteristic Ranges of Soy Whey Proteins

| | ranges, | ranges, | combined |
|---|---|---|---|
| | leper | St. Louis | SWP range |
| Moisture | 2.94-9.34 | 3.91-8.29 | 2.9-9.4 |
| protein_db | 71.0-89.3 | 62.48-85.17 | 62.4-89.3 |
| ash_ db | 1.19-6.23 | 1.19-13.57 | 1.19-13.57 |
| fat_db | 0.201-1.11 | 0.14-1.57 | 0.14-1.57 |
| carbohydrate | 7.2-23.7 | 5.4-30.5 | 5.4-30.5 |
| by diff _ db | (10 & 20 kDa | | |
| | membrane) | | |
| | | St. Louis | combined |
| | leper SWP | SWP | range |
| SSI %, pH 3.0 | 79-99 | 71.6-100 | 71-100 |
| SSI %, pH 4.0 | 68.7-97.3 | 67.4-94.7 | 67-98 |
| SSI %, pH 5.0 | 70.4-88.9 | 69.4-91.5 | 69-92 |
| SSI %, pH 6.0 | 79.1-93.49 | 75.1-100 | 75-100 |
| SSI %, pH 7.0 | 77.6-97.2 | 79.6-100 | 77-100 |
| viscosity, cPs | 3.6-7.5 | 3.3 (1 sample | 3.3-7.5 |
| | | only) | |

### III. Aqueous Whey Streams

Aqueous whey streams and molasses streams, which are types of soy processing streams, are generated from the process of refining a whole legume or oilseed. The whole legume or oilseed may be derived from a variety of suitable plants. By way of non-limiting example, suitable plants include leguminous plants, including for example, soybeans, corn, peas, canola, sunflowers, sorghum, rice, amaranth, potato, tapioca, arrowroot, canna, lupin, rape, wheat, oats, rye, barley, and mixtures thereof. In one embodiment, the leguminous plant is soybean and the aqueous whey stream generated from the process of refining the soybean is an aqueous soy whey stream.

Aqueous soy whey streams generated in the manufacture of soy protein isolates are generally relatively dilute and are typically discarded as waste. More particularly, the aqueous soy whey stream typically has a total solids content of less than about 10 wt. %, typically less than about 7.5 wt. % and, still more typically, less than about 5 wt. %. For example, in various aspects, the solids content of the aqueous soy whey stream is from about 0.5 to about 10 wt. %, from about 1 wt. % to about 4 wt. %, or from about 1 to about 3 wt. % (e.g. about 2 wt. %). Thus, during commercial soy protein isolate production, a significant volume of waste water that must be treated or disposed is generated.

Soy whey streams typically contain a significant portion of the initial soy protein content of the starting material soybeans. As used herein the term “soy protein” generally refers to any and all of the proteins native to soybeans. Naturally occurring soy proteins are generally globular proteins having a hydrophobic core surrounded by a hydrophilic shell. Numerous soy proteins have been identified including, for example, storage proteins such as glycinin and β-conglycinin. Soy proteins likewise include protease inhibitors, such as the above-noted BBI proteins. Soy proteins also include hemagglutinins such as lectin, lipoxygenases, β-amylase, and lunasin. It is to be noted that the soy plant may be transformed to produce other proteins not normally expressed by soy plants. It is to be understood that reference herein to “soy proteins” likewise contemplates proteins thus produced.

On a dry weight basis, soy proteins constitute at least about 10 wt. %, at least about 15 wt. %, or at least about 20 wt. % of the soy whey stream (dry weight basis). Typically, soy proteins constitute from about 10 to about 40 wt. %, or from about 25 to about 30 wt. % of the soy whey stream (dry weight basis). Soy protein isolates typically contain a significant portion of the storage proteins of the soybean. However, the soy whey stream remaining after isolate precipitation likewise contains one or more soy storage proteins.

In addition to the various soy proteins, the aqueous soy whey stream likewise comprises one or more carbohydrates (i.e. sugars). Generally, sugars constitute at least about 25%, at least about 35%, or at least about 45% by weight of the soy whey stream (dry weight basis). Typically, sugars constitute from about 25% to about 75%, more typically from about 35% to about 65% and, still more typically, from about 40% to about 60% by weight of the soy whey stream (dry weight basis).

The sugars of the soy whey stream generally include one or more monosaccharides, and/or one or more oligosaccharides or polysaccharides. For example, in various aspects, the soy whey stream comprises monosaccharides selected from the group consisting of glucose, fructose, and combinations thereof. Typically, monosaccharides constitute from about 0.5% to about 10 wt. % and, more typically from about 1% to about 5 wt. % of the soy whey stream (dry weight basis). Further in accordance with these and various other aspects, the soy whey stream comprises oligosaccharides selected from the group consisting of sucrose, raffinose, stachyose, and combinations thereof. Typically, oligosaccharides constitute from about 30% to about 60% and, more typically, from about 40% to about 50% by weight of the soy whey stream (dry weight basis).

The aqueous soy whey stream also typically comprises an ash fraction that includes a variety of components including, for example, various minerals, isoflavones, phytic acid, citric acid, saponins, and vitamins. Minerals typically present in the soy whey stream include sodium, potassium, calcium, phosphorus, magnesium, chloride, iron, manganese, zinc, copper, and combinations thereof. Vitamins present in the soy whey stream include, for example, thiamine and riboflavin. Regardless of its precise composition, the ash fraction typically constitutes from about 5% to about 30% and, more typically, from about 10% to about 25% by weight of the soy whey stream (dry weight basis).

The aqueous soy whey stream also typically comprises a fat fraction that generally constitutes from about 0.1% to about 5% by weight of the soy whey stream (dry weight basis). In certain aspects of the invention, the fat content is measured by acid hydrolysis and is about 3% by weight of the soy whey stream (dry weight basis).

In addition to the above components, the aqueous soy whey stream also typically comprises one or more microorganisms including, for example, various bacteria, molds, and yeasts. The proportions of these components typically vary from about 100 to about 1×10⁹ colony forming units (CFU) per milliliter. As detailed elsewhere herein, in various aspects, the aqueous soy whey stream is treated to remove these component(s) prior to protein recovery and/or isolation.

As noted, conventional production of soy protein isolates typically includes disposal of the aqueous soy whey stream remaining following isolation of the soy protein isolate. In accordance with the present disclosure, recovery of one or more proteins and various other components (e.g. sugars and minerals) results in a relatively pure aqueous whey stream. Conventional soy whey streams from which the protein and one or more components have not been removed generally require treatment prior to disposal and/or reuse. In accordance with various aspects of the present disclosure the aqueous whey stream may be disposed of or utilized as process water with minimal, if any, treatment. For example, the aqueous whey stream may be used in one or more filtration (e.g. diafiltration) operations of the present disclosure.

In addition to recovery of BBI proteins from aqueous soy whey streams generated in the manufacture of soy protein isolates, it is to be understood that the processes described herein are likewise suitable for recovery of one or more components of soy molasses streams generated in the manufacture of a soy protein concentrate, as soy molasses streams are an additional type of soy processing stream.

### IV. General Description of Process for Soy Whey Protein Recovery

Generally, the purification of the soy processing stream comprises one or more operations (e.g. membrane separation operations) selected and designed to provide recovery of the desired proteins or other products, or separation of various components of the soy whey stream, or both. Recovery of soy whey proteins (e.g. Bowman-Birk inhibitor (BBI) and Kunitz trypsin inhibitor (KTI) proteins) and one or more other components of the soy whey stream (e.g. various sugars, including oligosaccharides) may utilize a plurality of separation techniques, (e.g. membrane, chromatographic, centrifugation, or filtration). The specific separation technique will depend upon the desired component to be recovered by separating it from other components of the processing stream.

For example, a purified fraction is typically prepared by removal of one or more impurities (e.g. microorganisms or minerals), followed by removal of additional impurities including one or more soy storage proteins (i.e. glycinin and β-conglycinin), followed by removal of one or more soy whey proteins (including, for example, KTI and other non-BBI proteins or peptides), and/or followed by removal of one or more additional impurities including sugars from the soy whey. Recovery of various target components in high purity form is improved by removal of other major components of the whey stream (e.g. storage proteins, minerals, and sugars) that detract from purity by diluents, while likewise improving purity by purifying the protein fraction through removal of components that are antagonists to the proteins and/or have deleterious effects (e.g. endotoxins). Removal of the various components of the soy whey typically comprises concentration of the soy whey prior to and/or during removal of the components of the soy whey. The methods of the present invention also will reduce pollution generated from processing large quantities of aqueous waste.

Removal of storage proteins, sugars, minerals, and impurities yields fractions that are enriched in the individual, targeted proteins and free of impurities that may be antagonists or toxins, or may otherwise have a deleterious effect. For example, typically a soy storage protein-enriched fraction may be recovered, along with a fraction enriched in one or more soy whey proteins. A fraction enriched in one more sugars (e.g. oligosaccharides and/or polysaccharides) is also typically prepared. Thus, the present methods provide a fraction that is suitable as a substrate for recovery of individual, targeted proteins, and also provide other fractions that can be used as substrates for economical recovery of other useful products from aqueous soy whey. For example, removal of sugars and/or minerals from the soy whey stream produces a useful fraction from which the sugars can be further separated, thus yielding additional useful fractions: a concentrated sugar and a mineral fraction (that may include citric acid), and a relatively pure aqueous fraction that may be disposed of with minimal, if any, treatment or recycled as process water. Process water thus produced may be especially useful in practicing the present methods. Thus, a further advantage of the present methods may be reduced process water requirements as compared to conventional isolate preparation processes.

Methods of the present disclosure provide advantages over conventional methods for manufacture of soy protein isolates and concentrates in at least two ways. As noted, conventional methods for manufacturing soy protein materials typically dispose of the soy whey stream (e.g. aqueous soy whey or soy molasses). Thus, the products recovered by the methods of the present disclosure represent an additional product, and a revenue source not currently realized in connection with conventional soy protein isolate and soy protein concentrate manufacture. Furthermore, treatment of the soy whey stream or soy molasses to recover saleable products preferably reduces the costs associated with treatment and disposal of the soy whey stream or soy molasses. For example, as detailed elsewhere herein, various methods of the present invention provide a relatively pure soy processing stream that may be readily utilized in various other processes or disposed of with minimal, if any, treatment, thereby reducing the environmental impact of the process. Certain costs exist in association with the methods of the present disclosure, but the benefits of the additional product(s) isolated and minimization of waste disposal are believed to compensate for any added costs.

The following is a general description of the various steps that make up the overall process. A key to the process is to start with the whey protein pretreatment step, which uniquely changes the soy whey and protein properties. From there, the other steps may be performed using the raw material sources as listed in each step, as will be shown in the discussion of the various embodiments to follow.

It is understood by those skilled in the art of separation technology that there can be residual components in each permeate or retentate stream since separation is never 100%. Further, one skilled in the art realizes that separation technology can vary depending on the starting raw material.

Step 0 (as shown in FIG. 4A)—Whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 1 (as shown in FIG. 4A)—Microbiology reduction can start with the product of the whey protein pretreatment step, including but not limited to pre-treated soy whey. This step involves microfiltration of the pre-treated soy whey. Process variables and alternatives in this step include but are not limited to, centrifugation, dead-end filtration, heat sterilization, ultraviolet sterilization, microfiltration, crossflow membrane filtration, and combinations thereof. Crossflow membrane filtration includes but is not limited to: spiral-wound, plate and frame, hollow fiber, ceramic, dynamic or rotating disk, nanofiber, and combinations thereof. The pH of step 1 can be between about 2.0 and about 12.0, preferably about 5.3. The temperature can be between about 5° C. and about 90° C., preferably about 50° C. Products from step 1 include but are not limited to storage proteins, microorganisms, silicon, and combinations thereof in stream 1a (retentate) and purified pre-treated soy whey in stream 1b (permeate).

Step 2 (as shown in FIG. 4A)—A water and mineral removal can start with the purified pre-treated soy whey from stream 1b or 4a, or pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (as shown in FIG. 4A)—the mineral precipitation step can start with purified pre-treated soy whey from stream 2a or pretreated soy whey from streams 0a or 1b. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (as shown in FIG. 4A)—the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (as shown in FIG. 4B)—the protein separation and concentration step can start with purified pre-treated whey from stream 4a or the whey from streams 0a, 1b, or 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (as shown in FIG. 4B)—the protein washing and purification step can start with soy whey protein, BBI, KTI, storage proteins, other proteins or purified pre-treated whey from stream 4a or 5a, or whey from streams 0a, 1b, or 2a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 7 (as shown in FIG. 4C)—a water removal step can start with peptides, soy oligosaccharides, water, minerals, and combinations thereof from stream 5b and/or stream 6b. Soy oligosaccharides include but are not limited to sucrose, raffinose, stachyose, verbascose, monosaccharides, and combinations thereof. It includes a nanofiltration step. Process variables and alternatives in this step include but are not limited to, reverse osmosis, evaporation, nanofiltration, water diafiltration, buffer diafiltration, and combinations thereof. The pH of step 7 can be between about 2.0 and about 12.0, preferably about 7.0. The temperature can be between about 5° C. and about 90° C., preferably about 50° C. Products from stream 7a (retentate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Products from stream 7b (permeate) include but are not limited to, water, minerals, and combinations thereof.

Step 8 (as shown in FIG. 4C)—a mineral removal step can start with peptides, soy oligosaccharides, water, minerals, and combinations thereof from streams 5b, 6b, 7a, and/or 12a. Soy oligosaccharides include but are not limited to sucrose, raffinose, stachyose, verbascose, monosaccharides, and combinations thereof. It includes an electrodialysis membrane step. Process variables and alternatives in this step include but are not limited to, ion exchange columns, chromatography, and combinations thereof. Processing aids that can be used in this mineral removal step include but are not limited to, water, enzymes, and combinations thereof. Enzymes include but are not limited to protease, phytase, and combinations thereof. The pH of step 8 can be between about 2.0 and about 12.0, preferably about 7.0. The temperature can be between about 5° C. and about 90° C., preferably about 40° C. Products from stream 8a (retentate) include but are not limited to, de-mineralized soy oligosaccharides with conductivity between about 10 milli Siemens (mS) and about 0.5 mS, preferably about 2 mS, and combinations thereof. Soy oligosaccharides include but are not limited to sucrose, raffinose, stachyose, verbascose, monosaccharides, and combinations thereof. Products from stream 8b include but are not limited to, minerals, water, and combinations thereof.

Step 9 (as shown in FIG. 4C)—a color removal step can start with de-mineralized soy oligosaccharides from streams 8a, 5b, 6b, and/or 7a). It utilizes an active carbon bed. Process variables and alternatives in this step include but are not limited to, ion exchange. Processing aids that can be used in this color removal step include but are not limited to, active carbon, ion exchange resins, and combinations thereof. The temperature can be between about 5° C. and about 90° C., preferably about 40° C. Products from stream 9a (retentate) include but are not limited to, color compounds. Stream 9b is decolored. Products from stream 9b (permeate) include but are not limited to, soy oligosaccharides, and combinations thereof. Soy oligosaccharides include but are not limited to sucrose, raffinose, stachyose, verbascose, monosaccharides, and combinations thereof.

Step 10 (as shown in FIG. 4C)—a soy oligosaccharide fractionation step can start with soy oligosaccharides, and combinations thereof from streams 9b, 5b, 6b, 7a, and/or 8a. Soy oligosaccharides include but are not limited to sucrose, raffinose, stachyose, verbascose, monosaccharides, and combinations thereof. It includes a chromatography step. Process variables and alternatives in this step include but are not limited to, chromatography, nanofiltration, and combinations thereof. Processing aids that can be used in this soy oligosaccharide fractionation step include but are not limited to acid and base to adjust the pH as one know in the art and related to the resin used. Products from stream 10a (retentate) include but are not limited to, soy oligosaccharides such as sucrose, monosaccharides, and combinations thereof. Products from stream 10b (permeate) include but are not limited to soy oligosaccharides such as, raffinose, stachyose, verbascose, and combinations thereof.

Step 11 (as shown in FIG. 4C)—a water removal step can start with soy oligosaccharides such as, raffinose, stachyose, verbascose, and combinations thereof from streams 9b, 5b, 6b, 7a, 8a, and/or 10a. It includes an evaporation step. Process variables and alternatives in this step include but are not limited to, evaporation, reverse osmosis, nanofiltration, and combinations thereof. Processing aids that can be used in this water removal step include but are not limited to, defoamer, steam, vacuum, and combinations thereof. The temperature can be between about 5° C. and about 90° C., preferably about 60° C. Products from stream 11a (retentate) include but are not limited to, water. Products from stream 11b (permeate) include but are not limited to, soy oligosaccharides, such as, raffinose, stachyose, verbascose, and combinations thereof.

Step 12 (as shown in FIG. 4C)—an additional protein separation from soy oligosaccharides step can start with peptides, soy oligosaccharides, water, minerals, and combinations thereof from stream 7b. Soy oligosaccharides include but are not limited to sucrose, raffinose, stachyose, verbascose, monosaccharides, and combinations thereof. It includes an ultrafiltration step. Process variables and alternatives in this step include but are not limited to, crossflow membrane filtration, ultrafiltration with pore sizes between about 50 kD and about 1 kD, and combinations thereof. Crossflow membrane filtration includes but is not limited to: spiral-wound, plate and frame, hollow fiber, ceramic, dynamic or rotating disk, nanofiber, and combinations thereof. Processing aids that can be used in this protein separation from sugars step include but are not limited to, acids, bases, protease, phytase, and combinations thereof. The pH of step 12 can be between about 2.0 and about 12.0, preferably about 7.0. The temperature can be between about 5° C. and about 90° C., preferably about 75° C. Products from stream 12a (retentate) include but are not limited to, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate. This stream 12a stream can be fed to stream 8. Products from stream 12b (permeate) include but are not limited to, peptides, and other proteins. Other proteins include but are not limited to lunasin, lectins, dehydrins, lipoxygenase, and combinations thereof.

Step 13 (as shown in FIG. 4C)—a water removal step can start with, peptides, and other proteins. Other proteins include but are not limited to lunasin, lectins, dehydrins, lipoxygenase, and combinations thereof. It includes an evaporation step. Process variables and alternatives in this step include but are not limited to, reverse osmosis, nanofiltration, spray drying and combinations thereof. Products from stream 13a (retentate) include but are not limited to, water. Products from stream 13b (permeate) include but are not limited to, peptides, other proteins, and combinations thereof. Other proteins include but are not limited to lunasin, lectins, dehydrins, lipoxygenase, and combinations thereof.

Step 14 (as shown in FIG. 4B)—a protein fractionation step may be done by starting with soy whey protein, BBI, KTI, storage proteins, other proteins, and combinations thereof from streams 6a and/or 5a. Other proteins include but are not limited to lunasin, lectins, dehydrins, lipoxygenase, and combinations thereof. It includes an ultrafiltration (with pore sizes from 100 kD to 10 kD) step. Process variables and alternatives in this step include but are not limited to, crossflow membrane filtration, ultrafiltration, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 14 can be between about 2.0 and about 12.0, preferably about 7.0. The temperature can be between about 5° C. and about 90° C., preferably about 75° C. Products from stream 14a (retentate) include but are not limited to, storage proteins. Products from stream 14b (permeate) include but are not limited to, soy whey protein, BBI, KTI and, other proteins. Other proteins include but are not limited to lunasin, lectins, dehydrins, lipoxygenase, and combinations thereof.

Step 15 (as shown in FIG. 4B)—a water removal step can start with soy whey protein, BBI, KTI and, other proteins from streams 6a, 5a, and/or 14b. Other proteins include but are not limited to lunasin, lectins, dehydrins, lipoxygenase, and combinations thereof. It includes an evaporation step. Process variables and alternatives in this step include but are not limited to, evaporation, nanofiltration, RO, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (as shown in FIG. 4B)—a heat treatment and flash cooling step can start with soy whey protein, BBI, KTI and, other proteins from streams 6a, 5a, 14b, and/or 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Step 17 (as shown in FIG. 4B)—a drying step can start with soy whey protein, BBI, KTI and, other proteins from streams 6a, 5a, 14b, 15b, and/or 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

The soy whey protein products of the current application include raw whey, a soy whey protein precursor after the ultrafiltration step of Step 17, a dry soy whey protein that can be dried by any means known in the art, and combinations thereof. All of these products can be used as is as soy whey protein or can be further processed to purify specific components of interest, such as, but not limited to BBI, KTI, and combinations thereof.

### IV. Preferred Embodiments of the Process for the Recovery of Soy Whey Protein

Embodiment 1 starts with Step 0 (See FIG. 4A) as follows: Whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof. Next

Step 5 (See FIG. 4B) is done. Thus, the protein separation and concentration step in this embodiment starts with the whey from stream 0a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Embodiment 2—starts with Step 0 (See FIG. 4A) as follows: Whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Next Step 5 (See FIG. 4B) is done. Thus, the protein separation and concentration step in this embodiment starts with the whey from stream 0a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Finally Step 6 (See FIG. 4B), the protein washing and purification step starts with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Embodiment 3 starts with Step 0 (See FIG. 4A) which is a whey protein pretreatment that can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 3 (See FIG. 4A) the mineral precipitation step can start with purified pre-treated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Finally, Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Embodiment 4 starts with Step 0 (See FIG. 4A) whey protein pretreatment that can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 3 (See FIG. 4A) the mineral precipitation step can start with purified pre-treated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A)—the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B)—the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Finally, Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Embodiment 5 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 3 (See FIG. 4A) the mineral precipitation step can start with pre-treated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A)—the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B)—the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 16 (See FIG. 4B) a heat treatment and flash cooling step can start with soy whey protein, BBI, KTI and, other proteins from streams 6a. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B)—a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 6 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 3 (See FIG. 4A) the mineral precipitation step can start with pre-treated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 15 (See FIG. 4B) a water removal step can start with soy whey protein, BBI, KTI and, other proteins from stream 6a. Other proteins include but are not limited to lunasin, lectins, dehydrins, lipoxygenase, and combinations thereof. It includes an evaporation step. Process variables and alternatives in this step include but are not limited to, evaporation, nanofiltration, RO, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (See FIG. 4B) a heat treatment and flash cooling step can start with soy whey protein, BBI, KTI and, other proteins from stream 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B)—a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 7 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 2 (See FIG. 4A) a water and mineral removal can start with the pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Finally, Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Embodiment 8 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 2 (See FIG. 4A) a water and mineral removal can start with the pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Finally, Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Embodiment 9 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 2 (See FIG. 4A) a water and mineral removal can start with the pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (See FIG. 4A) the mineral precipitation step can start with purified pre-treated soy whey from stream 2a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Embodiment 10 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 2 (See FIG. 4A) a water and mineral removal can start with the pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (See FIG. 4A) the mineral precipitation step can start with purified pre-treated soy whey from stream 2a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Finally, Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Embodiment 11 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 2 (See FIG. 4A) a water and mineral removal can start with the pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (See FIG. 4A) the mineral precipitation step can start with purified pre-treated soy whey from stream 2a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A)—the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B)—the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 16 (See FIG. 4B) a heat treatment and flash cooling step can start with soy whey protein, BBI, KTI and, other proteins from stream 6a. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B)—a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 12 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 2 (See FIG. 4A) a water and mineral removal can start with the purified pre-treated soy whey from stream 1b or pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (See FIG. 4A) the mineral precipitation step can start with purified pre-treated soy whey from stream 2a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 15 (See FIG. 4B) a water removal step can start with soy whey protein, BBI, KTI and, other proteins from stream 6a. Other proteins include but are not limited to lunasin, lectins, dehydrins, lipoxygenase, and combinations thereof. It includes an evaporation step. Process variables and alternatives in this step include but are not limited to, evaporation, nanofiltration, RO, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (See FIG. 4B) a heat treatment and flash cooling step can start with soy whey protein, BBI, KTI and, other proteins from stream 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B) a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 13 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kD) in stream 0a (retentate) and insoluble large molecular weight proteins (between about 300 kDa and between about 50 kDa) in stream 0b (permeate), such as pre-treated soy whey, storage proteins, and combinations thereof.

Step 3 (See FIG. 4A) the mineral precipitation step can start with pre-treated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 2 (See FIG. 4A) a water and mineral removal can start with the purified pre-treated soy whey from stream 1b or pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Finally, Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Embodiment 14 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 3 (See FIG. 4A) the mineral precipitation step can start with pretreated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 2 (See FIG. 4A) a water and mineral removal can start with the purified pre-treated soy whey from stream 4a. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Finally, Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Embodiment 15 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 3 (See FIG. 4A) the mineral precipitation step can start with pretreated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 2 (See FIG. 4A) a water and mineral removal can start with the purified pre-treated soy whey from stream 1b or pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 16 (See FIG. 4B) a heat treatment and flash cooling step can start with soy whey protein, BBI, KTI and, other proteins from stream 6a. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B) a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 16 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 3 (See FIG. 4A) the mineral precipitation step can start with pretreated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 2 (See FIG. 4A) a water and mineral removal can start with the purified pre-treated soy whey from stream 4a. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 15 (See FIG. 4B) a water removal step can start with soy whey protein, BBI, KTI and, other proteins from stream 6a. Other proteins include but are not limited to lunasin, lectins, dehydrins, lipoxygenase, and combinations thereof. It includes an evaporation step. Process variables and alternatives in this step include but are not limited to, evaporation, nanofiltration, RO, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (See FIG. 4B) a heat treatment and flash cooling step can start with soy whey protein, BBI, KTI and, other proteins from stream 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B) a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 17 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 1 (See FIG. 4A) Microbiology reduction can start with the product of the whey protein pretreatment step, including but not limited to pre-treated soy whey. This step involves microfiltration of the pre-treated soy whey. Process variables and alternatives in this step include but are not limited to, centrifugation, dead-end filtration, heat sterilization, ultraviolet sterilization, microfiltration, crossflow membrane filtration, and combinations thereof. Crossflow membrane filtration includes but is not limited to: spiral-wound, plate and frame, hollow fiber, ceramic, dynamic or rotating disk, nanofiber, and combinations thereof. The pH of step 1 can be between about 2.0 and about 12.0, preferably about 5.3. The temperature can be between about 5° C. and about 90° C., preferably about 50° C. Products from step 1 include but are not limited to storage proteins, microorganisms, silicon, and combinations thereof in stream 1a (retentate) and purified pre-treated soy whey in stream 1b (permeate).

Step 3 (See FIG. 4A) the mineral precipitation step can start with pretreated soy whey from stream 1 b. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 2 (See FIG. 4A)—A water and mineral removal can start with the purified pre-treated soy whey from stream 4a. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 15 (See FIG. 4B) a water removal step can start with soy whey protein, BBI, KTI and, other proteins from stream 6a. Other proteins include but are not limited to lunasin, lectins, dehydrins, lipoxygenase, and combinations thereof. It includes an evaporation step. Process variables and alternatives in this step include but are not limited to, evaporation, nanofiltration, reverse osmosis, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (See FIG. 4B) a heat treatment and flash cooling step can start with soy whey protein, BBI, KTI and, other proteins from stream 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B) a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 18 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 1 (See FIG. 4A) Microbiology reduction can start with the product of the whey protein pretreatment step, including but not limited to pre-treated soy whey. This step involves microfiltration of the pre-treated soy whey. Process variables and alternatives in this step include but are not limited to, centrifugation, dead-end filtration, heat sterilization, ultraviolet sterilization, microfiltration, crossflow membrane filtration, and combinations thereof. Crossflow membrane filtration includes but is not limited to: spiral-wound, plate and frame, hollow fiber, ceramic, dynamic or rotating disk, nanofiber, and combinations thereof. The pH of step 1 can be between about 2.0 and about 12.0, preferably about 5.3. The temperature can be between about 5° C. and about 90° C., preferably about 50° C. Products from step 1 include but are not limited to storage proteins, microorganisms, silicon, and combinations thereof in stream 1a (retentate) and purified pre-treated soy whey in stream 1b (permeate).

Step 2 (See FIG. 4A) a water and mineral removal can start with the purified pre-treated soy whey from stream 1 b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (See FIG. 4A) the mineral precipitation step can start with purified pre-treated soy whey from stream 2a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A)—the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 15 (See FIG. 4B) a water removal step can start with soy whey protein, BBI, KTI and, other proteins from stream 6a. Other proteins include but are not limited to lunasin, lectins, dehydrins, lipoxygenase, and combinations thereof. It includes an evaporation step. Process variables and alternatives in this step include but are not limited to, evaporation, nanofiltration, reverse osmosis, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (See FIG. 4B) a heat treatment and flash cooling step can start with soy whey protein, BBI, KTI and, other proteins from stream 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B) a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

### V. Food Products Comprising an Emulsifying Agent

The present invention further relates to food products that contain an emulsifying agent comprising an amount of soy whey protein having a SSI of at least about 80% across a pH range of from 2 to 10 and a temperature of 25° C. The emulsifying agent disclosed herein is suitable for use in a variety of food products, but is especially suitable for use in food products comprising immiscible liquids, such as, for example, whipped toppings, salad dressings, spreadable oils (including margarines having an oil concentration range of 10-80%), mayonnaises, baked dessert products (including cakes), beverages (including alcoholic beverages), soups, fondant, confections (such as meringues, nougats, etc.), coffee creamers (liquid or dry), fat powders, and the like. One of skill in the art will appreciate that the amount of emulsifying agent used can and will vary depending upon the desired food product.

In one embodiment, the food product comprising the emulsifying agent may be a dessert product, such as pudding, whipped topping, chocolate, fondant, gelatin, confections (such as nougat, meringue, etc.), cake, frozen confection, frozen dessert, and combinations thereof.

In another embodiment, the food product comprising the emulsifying agent may be a sauce product, such as ready made sauces, salad sauces, pan sauces, vegetable sauces, dessert sauces, chocolate sauces, caramel sauces, white sauces, brown sauces, emulsified sauces, sweet sauces, fruit sauces, jellies, jams, preserves, chutney, compotes, apple sauce, puddings, gelatin, molè sauces, sauce bases, such as espangole, veloutè, Béchamel, Hollandaise, cheese sauces, remoulades, salsas, relishes, cooked sauces, and combinations thereof.

In another embodiment, the food product comprising the emulsifying agent may be a spread or condiment product, such as cheese spreads, cream spreads, mayonnaise, salad dressings, spreadable oils (including margarines having an oil concentration range of 10-80%), nut butters including peanut butter, soy butter, almond butter, cashew butter, hazelnut butter, macadamia nut butter, pecan butter, pistachio butter, and walnut butter, and fruit butters such as apple butter, pumpkin butter, pear butter, mango butter, fig butter, and combinations thereof.

In another embodiment, the food product comprising the emulsifying agent may be a soup product, such as a ready-to serve or ready-to-eat soups, canned condensed soups; clear, thick, broths, cream, bisques, chowders, purees, meat and vegetable soups, soups with particulates, cold or chilled soups, dessert soups, seafood soups, beverage soups, fermented soups, and combinations thereof.

In another embodiment, the food product comprising the emulsifying agent may be a beverage product, including liquid refrigerated beverages and liquid shelf stable beverage, such as milk beverages, juice refresher beverages, milk shake beverages, ready to drink beverages (neutral or acidic), smoothie beverages, and combinations thereof.

Typically, the amount of emulsifying agent present in the food product can and will vary depending on the desired food product and the immiscibility of the liquids used to make the food product. By way of example, the food product may contain between about 0.01% and about 5% (by weight) of an emulsifying agent. Specifically, the food product may contain about 5%, 4%, 3%, 2.5%, 2%, 1.5%, 1%, 0.50%, 0.25%, 0.1%, 0.05% or 0.01% (by weight) of an emulsifying agent. In one embodiment, the amount of emulsifying agent present in the food product may range from about 0.01% to about 3% by weight. Additionally, the amount of emulsifying agent present in the food product may comprise between about 0.01% to about 2% by weight.

The emulsifying agent may be added at the initial hydration step or to the pre-mix or at a subsequent processing step in the preparation of the food product. In one embodiment, the emulsifying agent is added in water as part of the initial hydration of the protein followed by the addition of other ingredients, such as carbohydrates. In an alternative embodiment, the emulsifying agent is added to the dry ingredients in a dry form as part of the dry blend pre-mix before adding to the liquid ingredients. In an alternative embodiment, the emulsifying agent is added to the oil phase as part of the initial mixing, followed by addition of the other ingredients.

a. Additional Ingredients

In addition to the emulsifying agent containing an amount of soy whey protein, a variety of other ingredients may be added to the food product at the pre-blend or at a subsequent processing step without departing from the scope of the invention. For example, carbohydrates, dietary fiber, antioxidants, antimicrobial agents, fat sources, water, pH-adjusting agents, preservatives, dairy products, flavoring agents, sweetening agents, coloring agents, other nutrients, and combinations thereof may be included in the pre-blend for the food product.

### 1. Additional Emulsifier

The food product may optionally include at least one additional emulsifier such as, mono- and diglycerides of fatty acids, esters of monoglycerides of fatty acids, DATEM, propylene glycol monoesters, lecithin, hydroxylated lecithin, dioctyl sodium sulphosuccinate, SSL, CSL, Polysorbate 20, Polysorbate 40, Polysorbate 60, Polysorbate 80, sorbitan tristearate, stearyl citrate, PGPR, caseinate, and combinations thereof. As will be appreciated by one of skill in the art, the amount of additional emulsifier, if any, added to the food product can and will depend upon the type of food product desired.

### 2. Protein-Containing Material

In addition to the soy whey protein present in the emulsifying agent, other protein-containing materials may optionally be present in the food product. While ingredients comprising proteins derived from plants, such as soy protein, pea protein, corn protein, potato protein, and canola protein are typically used, it is also envisioned that proteins derived from other sources, such as animal sources, may be utilized without departing from the scope of the invention. For example, a dairy protein selected from the group consisting of casein, caseinates, milk protein concentrate, whey protein concentrate, whey protein isolate, and mixtures thereof, may be utilized. By way of further example, an egg protein selected from the group consisting of ovalbumin, ovoglobulin, ovomucin, ovomucoid, ovotransferrin, ovovitella, ovovitellin, albumen, globulin, vitellin, and combinations thereof may be used.

### 3. Carbohydrate Source

The food product may further include at least one carbohydrate source. Generally, the carbohydrate source is starch (pre-gelatinized starch or a modified food starch), sugar, or flour (for example wheat, rice, corn, peanut, or konjac). Suitable starches are known in the art and may include starches derived from vegetables (including legumes) or grains. Non-limiting examples of suitable carbohydrates may include fiber, such as oligofructose and soy fiber, guar gum, locust bean gum, carrageenans, starch derived from corn, potato, rice, wheat, arrowroot, guar gum, locust bean, tapioca, arracacha, buckwheat, banana, barley, cassava, konjac, kudzu, oca, sago, sorghum, sweet potato, taro, yams, and mixtures thereof. Edible legumes, such as soy, favas, lentils and peas are also rich in suitable carbohydrates. Non-limiting examples of suitable sugars include sucrose, dextrose, lactose, fructose, galactose, maltodextrin, maltose, mannose, glucose, and combinations thereof.

Regardless of the specific carbohydrate source used, the percentage of starch and or type of carbohydrate (e.g., maltodextrin low dextrose equivalent (DE) vs. high DE corn syrup solids) utilized in the food product typically determines, in part, its texture when it is expanded. As such, the amount of carbohydrates present in the food product can and will vary depending on the desired texture of the resultant food product. For example, the amount of carbohydrates present in the food product may range from about 1% to about 30% by weight. In another embodiment, the amount of carbohydrates present in the food product may range from about 3% to about 20% by weight. In an additional embodiment, the amount of carbohydrates that may be present in the food product may range from about 5% to about 10% by weight.

### 4. Fat Source

The food product may contain at least one fat source which may be liquid or solid at room temperature. Non-limiting examples of suitable fats include edible oils that are liquid at room temperature, such as for example, rapeseed oil, soybean oil, sunflower oil, canola oil, corn oil, olive oil, peanut oil, cottonseed oil, vegetable oil, and any other fat source that is liquid at room temperature (e.g., cream), as well as fats that are solid at room temperature, for example palm oil, coconut oil, shortening, margarine, butter, lard, etc. In one embodiment, the food product may contain vegetable oil. In another embodiment, the food product may contain butter. The amount of fat present in the food product will depend, in part, on the type of fat used and desired food product. Generally, the food product may comprise between about 0% and about 80% by weight of at least one fat source. In one embodiment, the food product may comprise between about 0% and about 30% by weight of at least one fat source.

### 5. Stabilizer

The food product comprising the emulsifying agent may optionally contain a stabilizer to inhibit the separation of the food product into separate immiscible phases. Because the soy whey proteins prepared in accordance with the present invention have been found to further exhibit stabilizing properties in addition to emulsification properties, additional stabilizers may not be needed. However, non-limiting examples of suitable stabilizers in the art that could be used in addition to soy whey protein include pectin, agar agar, locust bean gum, xanthan gum, guar gum, gum arabic, alginic acid, carrageenan, gelatin, potassium bitartrate (i.e., cream of tartar), and combinations thereof. The stabilizer may be present in the food product at a level from about 0.005% to about 10%, and preferably from about 0.025% to about 5%. As will be appreciated by one of skill in the art, the amount of stabilizer, if any, added to the food product can and will depend upon the type of food product desired.

### 6. Antioxidant

Antioxidant additives include ascorbic acid, butylated hydroxyanisole (BHA), butylated hydroxytoluene (BHT), tert-butylhydroquinone (TBHQ), lecithin, vitamins A, C, and E and derivatives, and various plant extracts such as rosemarinic acid and those containing carotenoids, tocopherols or flavonoids having antioxidant properties, may be included to increase the shelf-life or nutritionally enhance the food product. The antioxidants may have a presence at levels from about 0.001% to about 1% by weight of the composition.

### 7. pH-Adjusting Agent

In some embodiments, it may be desirable to lower or raise the pH of the food product depending on the type of food product desired. Thus, the combined food ingredients may be contacted with a pH-adjusting agent. In one embodiment, the pH of the combined ingredients may range from about 2.5 to about 8.0. In another embodiment, the pH of the combined ingredients may be higher than about 7.2. In yet another embodiment, the pH of the combined ingredients may be lower than about 4.0. Several pH-adjusting agents are suitable for use in the invention. The pH-adjusting agent may be organic or alternatively, it may be inorganic. In exemplary embodiments, the pH-adjusting agent is a food grade edible acid. Non-limiting acids suitable for use in the invention include acetic, lactic, hydrochloric, phosphoric, citric, tartaric, malic, glucono, deltalactone, gluconic, and combinations thereof. In an exemplary embodiment, the pH-adjusting agent is citric acid. In an alternative embodiment, the pH-adjusting agent may be a pH-raising agent, such as but not limited to disodium diphosphate, sodium hydroxide, and potassium hydroxide. As will be appreciated by a skilled artisan, the amount of pH-adjusting agent placed in contact with the combined ingredients can and will vary depending on several parameters, including, the agent selected and the desired pH.

### 8. Flavorings

The food product may optionally include a variety of flavorings, spices, or other ingredients to naturally enhance the taste of the final food product. As will be appreciated by a skilled artisan, the selection of ingredients added to the food product can and will depend upon the type of food product desired.

In one embodiment, the food product may further comprise a flavoring agent. The flavoring agent may include any suitable edible flavoring agent known in the art including, but not limited to, salt, any flower flavor, any spice flavor, vanilla, any fruit flavor, caramel, nut flavor, beef, poultry (e.g. chicken or turkey), pork or seafood flavors, dairy flavors such as butter and cheese, any vegetable flavor, and combinations thereof.

The flavoring may also be sweet. Sugar, sweet dairy whey, soy molasses, corn syrup solids, honey, glucose, sucrose, fructose, maltodextrin, sucralose, aspartame, neotame, corn syrup (liquid or solids), acesulfame potassium, stevia, monk fruit extract, maple syrup, etc. may be used for sweet flavors. Additionally, other sweet flavors may be used (e.g., chocolate, chocolate mint, caramel, toffee, butterscotch, mint, coconut, and peppermint flavorings). Sugar alcohols may also be used as sweeteners.

A wide variety of fruit, citrus flavors, or citrus oils may also be used in the food product. Non-limiting examples of fruit or citrus flavors include strawberry, banana, raspberry, pineapple, coconut, cherry, orange, and lemon flavors.

Herbs, herb oils, or herb extracts that may be added include basil, celery leaves, chervil, chives, cilantro, parsley, oregano, rosemary, tarragon, and thyme.

### 9. Dairy Product

The food product may optionally include an ingredient that is a dairy product. Suitable non-limiting examples of dairy products that may additionally be added to the food product are skim milk, reduced fat milk, 2% milk, whole milk, cream, ice cream, evaporated milk, yogurt, buttermilk, dry milk powder, non-fat dry milk powder, milk proteins, acid casein, caseinate (e.g., sodium caseinate, calcium caseinate, etc.), whey protein concentrate, whey protein isolate, and combinations thereof.

### 10. Coloring Agent

In an additional embodiment, the food product may further comprise a coloring agent. The coloring agent may be any suitable food coloring, additive, dye or lake known to those skilled in the art. Suitable food colorants may include, but are not limited to, for example, Food, Drug and Cosmetic (FD&C) Blue No. 1, FD&C Blue No. 2, FD&C Green No. 3, FD&C Red No. 3, FD&C Red No. 40, FD&C Yellow No. 5, FD&C Yellow No. 6, Orange B, Citrus Red No. 2 and combinations thereof. Other coloring agents may include annatto extract, β-apo-8′-carotenal, β-carotene, beet powder, canthaxanthin, astaxanthin, caramel color, carrot oil, cochineal extract, cottonseed flour, ferrous gluconate, fruit juice, grape color extract, paprika, riboflavin, saffron, titanium dioxide, turmeric, and vegetable juice. These coloring agents may be combined or mixed as is common to those skilled in the art to produce a final coloring agent.

### 11. Nutrients

In a further embodiment, the food product may further comprise a nutrient such as a vitamin, a mineral, an antioxidant, an omega-3 fatty acid, or an herb. Suitable vitamins include Vitamins A, C and E, which are also antioxidants, and Vitamins B and D. Examples of minerals that may be added include the salts of aluminum, ammonium, calcium, magnesium, and potassium. Suitable omega-3 fatty acids include docosahexaenoic acid (DHA), stearidonic acid (SDA), hexadecatrienoic acid (HTA), α-linolenic acid (ALA), eicosatrienoic acid (ETE), eicosatetraenoic acid (ETA), eicosapentaenoic acid (EPA), arachidonic acid (ARA), heneicosapentaenoic acid (HPA), docosapentaenoic acid (DPA), tetracosapentaenoic acid, tetracosahexanenoic acid, and combinations thereof.

### VI. Method of Making Food Products

As referenced herein, the food products comprising an emulsifying agent containing an amount of soy whey protein may undergo typical processing known in the industry to produce the desired food product. Generally speaking, any method of processing known in the industry can be used to produce the desired food products.

For example, in one embodiment, the food products that include the emulsifying agent may undergo processing involving ingredient blending and a heat treatment step. In another embodiment, the compositions may additionally undergo a sterile filtration step. In another embodiment, the compositions may additionally undergo pasteurization either prior or subsequent to any initial heat treatment. In a further embodiment, the compositions may additionally undergo homogenization prior to, subsequent to or in lieu of pasteurization. In yet another embodiment, the compositions may additionally be cooled in accordance with typical industry standards following the heat treatment, pasteurization and/or homogenization, prior to packaging a food product. The cooling of the food product may include refrigeration, freezing, or a combination of both.

### DEFINITIONS

The following definitions and abbreviations are to be used for the interpretation of the claims and the specification.

The term “acid soluble” as used herein refers to a substance having a solubility of at least about 80% with a concentration of 10 grams per liter (g/L) in an aqueous medium having a pH of from about 2 to about 7.

The terms “soy protein isolate” or “isolated soy protein,” as used herein, refer to a soy material having a protein content of at least about 90% soy protein on a moisture free basis.

The term “soluble solids index” or “SSI” as used herein refers to the solubility of a soy protein material in an aqueous solution as measured according to the following formula: SSI (%)=(Soluble Solids/Total Solids)×100. Soluble Solids and Total Solids are determined as provided in Example 17.

The term “other proteins” as used herein referred to throughout the application are defined as including but not limited to: lunasin, lectins, dehydrins, lipoxygenase, and combinations thereof.

The term “soy whey protein” as used herein is defined as including protein soluble at those pHs where soy storage proteins are typically insoluble, including but not limited to BBI, KTI, lunasin, lipoxygenase, dehydrins, lectins, and combinations thereof. Soy whey protein may further include storage proteins.

The term “proteins other than soy whey protein” is defined as any animal or vegetable protein other than soy protein.

The term “processing stream” as used herein refers to the secondary or incidental product derived from the process of refining a whole legume or oilseed, including an aqueous or solvent stream, which includes, for example, an aqueous soy extract stream, an aqueous soymilk extract stream, an aqueous soy whey stream, an aqueous soy molasses stream, an aqueous soy protein concentrate soy molasses stream, an aqueous soy permeate stream, and an aqueous tofu whey stream, and additionally includes soy whey protein, for example, in both liquid and dry powder form, that can be recovered as an intermediate product in accordance with the methods disclosed herein.

The term “food products” as used herein broadly refers to a mixture of a combination of safe and suitable ingredients including, but not limited to, an emulsifying agent containing an amount of soy whey protein, water, fat sources, proteins other than soy whey protein, and carbohydrates. Other ingredients such as additional emulsifiers, dairy products, sweeteners, pH-adjusting agents, antioxidants, nutrients, coloring agents, and flavorings and may also be included.

The term “industrial margarine” as used herein refers to Industrial Margarine as defined by The U.S. Food and Drug Administration (FDA) and The US Department of Agriculture (USDA) regulations as a plastic or liquid emulsion food product containing not less than 80% fat. It may contain optional ingredients with specific functions. The usual optional ingredients are water, milk or milk products, emulsifiers, flavoring materials, salt and other preservative. (FDA 21 CFR 166.110).

The terms “spreadable margarine” as used herein refers to all products resembling margarine that contain less than 80% but more than 40% fat are required to be labeled as spreads.

When introducing elements of the present invention or the preferred embodiments(s) thereof, the articles “a,” “an,” “the” and “said” are intended to mean that there are one or more of the elements. The terms “comprising,” “including” and “having” are intended to be inclusive and mean that there may be additional elements other than the listed elements.

The term “invention” or “present invention” as used herein is a non-limiting term and is not intended to refer to any single embodiment of the particular invention but encompasses all possible embodiments as described in the specification and the claims.

As used herein, the term “about” modifying the quantity of an ingredient of the invention employed refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

As various changes could be made in the above compounds, products and methods without departing from the scope of the invention, it is intended that all matter contained in the above description and in the examples given below, shall be interpreted as illustrative and not in a limiting sense.

### EXAMPLES

### Example 1

### Recovery and Fractionation of Soy Whey Protein from Aqueous Soy Whey Using Novel Membrane Process

145 liters of aqueous raw soy whey (not pre-treated) with a total solids content of 3.7% and dry basis protein content of 19.8% was microfiltered using two different membranes in an OPTISEP® 7000 module, manufactured by SmartFlow Technologies. The first membrane, BTS-25, was a polysulfone construction with 0.5 um pore size manufactured by Pall. Aqueous soy whey was concentrated to a 1.6× factor, at an average flux of 30 liters/meter2/hr (LMH). The concentrated aqueous soy whey was then passed through a modified polysulfone microfiltration membrane, MPS 0.45, manufactured by Pall. The aqueous soy whey was concentrated from 1.6× to 11× at an average flux of 28 LMH.

Permeate from the microfiltration process, 132 liters total, was then introduced into an OPTISEP® 7000 module with ultrafiltration membranes, RC100, which are 100 kDa regenerated cellulose membranes manufactured by Microdyn-Nadir. The microfiltered aqueous soy whey was concentrated to about 20× using a 20 L tank setup at an average flux of 30 LMH before being transferred to a 5 L tank setup in order to minimize the hold-up volume of the system. In the smaller tank, the aqueous soy whey was concentrated from 20× to 66× at an average flux rate of 9 LMH, reaching a final retentate volume of 2 liters. The final retentate was 24.0% total solids, and 83.0% dry basis protein content.

128 liters of sugar and mineral enriched RC100 permeate was then introduced into an OPTISEP® 7000 module with polysulfone thin film nanofiltration membranes with a 35% NaCl rejection rate, NF20, manufactured by Sepro. The feed was concentrated 18× at an average flux rate of 4.7 LMH. The retentate from this process step, 9 liters, was enriched in the various sugar species. The permeate stream from the NF20 separation process, 121 liters, contained the minerals and water.

The permeate of the NF20 process was then introduced into an OPTISEP® 3000 module with thin film reverse osmosis membranes with a 98.2% NaCl rejection rate, SG, manufactured by GE. The feed was concentrated 12× at an average flux rate of 8 LMH. The permeate of the SG membrane, 9.2 liters, consisted primarily of water, suitable for re-use in a process with minimal further treatment. The retentate of the SG process, 0.8 liters, consisted predominantly of a concentrated mineral fraction.

### Example 2

### Recovery and Fractionation of Soy Whey Protein from Soy Molasses Using Novel Membrane Process

61.7 liters of soy molasses with a total solids content of 62.7% and dry basis protein content of 18.5% was diluted with 61.7 liters of water prior to microfiltration. The diluted soy molasses was then microfiltered using an OPTISEP® 7000 module, manufactured by SmartFlow Technologies. The diluted soy molasses passed through a modified polysulfone microfiltration membrane, MPS 0.45, manufactured by Pall. The diluted soy molasses was concentrated to a 1.3× factor, at an average flux of 6 liters/meter2/hr (LMH).

Permeate from the microfiltration process, 25 liters total, was then introduced into an OPTISEP® 7000 module with ultrafiltration membranes, RC100, which are 100 kDa regenerated cellulose membranes manufactured by Microdyn-Nadir. The microfiltered diluted soy molasses was diafiltered with 2 volumes of water prior to being concentrated to 7.6× at an average flux of 20 LMH, reaching a final retentate volume of 2 liters. The final retentate was 17.5% total solids, and 22.0% dry basis protein content.

72 liters of sugar and mineral enriched RC100 permeate was then introduced into an OPTISEP® 7000 module with polysulfone thin film nanofiltration membranes with a 35% NaCl rejection rate, NF20, manufactured by Sepro. The feed was concentrated 3× at an average flux rate of 4.0 LMH. The retentate from this process step, 23 liters, was enriched in the various sugar species. The permeate stream from the NF20 separation process, 48 liters, contained the minerals and water.

A portion of the permeate of the NF20 process, 10 liters, was then introduced into an OPTISEP® 3000 module with thin film reverse osmosis membranes with a 98.2% NaCl rejection rate, SG, manufactured by GE. The feed was concentrated 6.7× at an average flux rate of 7.9 LMH. The permeate of the SG membrane, 8.5 liters, consisted primarily of water, suitable for re-use in a process with minimal further treatment. The retentate of the SG process, 1.5 liters, consisted predominantly of a concentrated mineral fraction.

### Example 3

### Capture of Bulk Soy Whey Protein from Defatted Soy Flour Extract

Defatted soy flour (DSF) was extracted by adding a 15:1 ratio of water to DSF at a pH of 7.8 and stirring for 20 minutes prior to filtration. The extract was microfiltered using an OPTISEP® 800 module, manufactured by SmartFlow Technologies. The microfiltration membrane, MMM-0.8, was a polysulfone and polyvinylpropylene construction with 0.8 um pore size manufactured by Pall. Aqueous soy extract was concentrated to a 2.0× factor, at an average flux of 29 liters/meter2/hr (LMH). Permeate from the microfiltration process was then introduced into an OPTISEP® 800 module with ultrafiltration membranes, RC100, which are 100 kDa regenerated cellulose membranes manufactured by Microdyn-Nadir. The microfiltered aqueous soy extract was concentrated to about 6.3× at an average flux rate of 50 LMH. The final retentate measured 84.7% dry basis protein content.

### Example 4

### Capture of Bulk Soy Whey Protein Using Continuous Separation Technology CSEP (Simulated Moving Bed Chromatography)

CSEP experiments were performed by passing feed material (soy whey) through a column (ID 1.55 cm, length 9.5 cm, volume 18 mL) packed with SP GibcoCel resin. The column was connected to a positive displacement pump and samples of flow through and eluates were collected at the outlet of the column. Different experimental conditions were used to determine the effect of feed concentration, feed flow rate and elution flow rate on the binding capacity of the resin.

Feed Concentration

Soy whey was prepared from the defatted soy flake. Briefly, one part of defatted flake was mixed with 15 parts of water at 32° C. The pH of the solution was adjusted to 7.0 using 2 M NaOH and proteins were extracted into the aqueous phase by stirring the solution for 15 min. The protein extract was separated from the insoluble material by centrifugation at 3000×g for 10 min. The pH of the collected supernatant was adjusted to 4.5 using 1 M HCl and the solution was stirred for 15 min followed by heating to a temperature of 57° C. This treatment resulted in precipitation of the storage proteins while the whey proteins remained soluble. The precipitated proteins were separated from the whey by centrifugation at 3000×g for 10 min.

In some cases, the soy whey was concentrated using a Lab-Scale Amicon DC-10LA ultrafiltration unit and Amicon 3K membrane. Prior to ultrafiltration, pH of soy whey was adjusted to 5.5 with 2 M NaOH to avoid membrane fouling at acidic conditions. 10 L of whey was processed with the flux at ˜100 mL/min. Once the concentration factor of 5 in the retentate was reached, both retentate and permeate streams were collected. Soy whey concentrates 2.5×, 3×, and 4× were prepared by mixing a known amount of permeate and 5× whey concentrate. The pH of all soy concentrates was readjusted if necessary to 4.5.

Feed Flow Rate

During dynamic adsorption, as fluid flows through the resin bed, the proteins are adsorbed by the resin and reach equilibrium with the liquid phase. As the whey is loaded onto the column, the bound protein band extends down the column and reaches equilibrium with the liquid phase. When the resin is saturated with adsorbed proteins, the concentration of the proteins in the liquid phase exiting the column will be similar to the protein concentration in the feed. The curve describing the change in the flow through concentration compared to the feed concentration with the passage of fluid is the breakthrough curve. The concentration of protein in the solid phase increases as the breakthrough curve is developed, and the adsorption wave moves through the bed. As more fluid is passed through the bed, the flow through concentration increases asymptotically to the incoming fluid stream and at the same time a similar phenomena is achieved with the solid phase.

The flow through protein concentration data at three different linear velocity rates were plotted against the column volumes of soy whey loaded (see FIG. 5). These data indicated that increasing the linear flow rate of loading by a factor of 3 resulted in about 10% increase in the unabsorbed proteins in the flow through after loading 6 column volumes of soy whey. Therefore the linear flow rate does not significantly impact the adsorption characteristics of the soy whey proteins with the SP Gibco resin. The equilibrium adsorption data (see FIG. 6) showed that the soy whey protein adsorbed on the resin (calculated using mass balance of protein feed to the system and the protein concentration in the flow through, in equilibrium with the protein in the liquid stream, and plotted against the column volumes passed through the resin bed) varied little with flow rate of the feed at the fluxes tested.

The profile of the breakthrough curve, where soy whey and soy whey concentrated by a factor of 3 and 5 was applied to an SP Gibco resin bed at 15 mL/min (8.5 cm/min linear flow rate), was similar with all three concentrations (see FIG. 7). This result indicated that as the feed protein concentration was increased the resin reached equilibrium with the protein concentration in the liquid stream by striving to reach maximum capacity. This increased adsorption is depicted in FIG. 8 where the protein concentration in the solid phase in equilibrium with the liquid phase has been plotted against the column volumes of soy whey passed through the bed. These data show that the protein adsorbed by the resin significantly increased with soy whey concentration factor, and hence the protein concentration in the soy whey (see FIG. 8). FIG. 9 shows the equilibrium characteristics of the resin and the flow through. This chart shows that as the number of column volumes were passed through the bed, the adsorption of proteins in the resin phase increased asymptotically but the protein content in the flow through also increased. Adsorption capacity can be increased by using concentrated whey and loading at high column volumes but this resulted in a relatively high protein content in the flow through. However, the high protein content in the flow through was minimized by counter current operation using a 2-stage adsorption strategy.

Based on the dynamic adsorption data (see FIG. 9), loading whey concentrated by factor >5 to achieve a protein concentration of >11 mg/mL and loading about 3.5 column volumes resulted in about 35 mg protein adsorbed per mL of resin, and the equilibrium protein concentration in the flow through was about 6.8 mg/mL. Presenting this primary flow through to another resin bed in a second pass (loading about 3.5 column volumes) resulted in a protein concentration in the flow through of about 1.3 mg/mL. Therefore, using two passes of adsorption and operating the chromatography in counter current mode resulted in adsorption of about 90% of the available soy protein that could be absorbed from soy whey at pH 4.5.

Elution Flow Rate

The effect of elution flow rate was investigated at three different flow rates and the recovery data are shown in Table 3. The recovery of protein at low flow rates in duplicate experiments resulted in recoveries of over 164% and 200%. The data indicate that eluting at 20 and 30 mL/min (11.3 and 17.0 cm/min, respectively) did not significantly affect the recoveries. Moreover, operating at higher flow rates achieved much faster elution (see FIG. 10), however at these higher flow rates a larger column volume of eluate was required to complete the elution (see FIG. 11). The need for a larger column volume of eluate was overcome by recycling the eluate which also reduced the total volume required for elution and also presented a more concentrated protein stream to the downstream ultrafiltration unit, reducing the membrane area needed for protein concentration.

TABLE 3
Elution and recovery of bound soy whey
proteins at three different flow rates.

| | ELUTION FLOW RATES | | |
|---|---|---|---|
| | 15 mL/min | 20 mL/min | 30 mL/min |
| Protein adsorbed (mg) | 75.4 ± 4.4 | 70.8 ± 2.7 | 72.9 ± 4.8 |
| Protein eluted (mg) | 139.7 ± 22.9 | 73.2 ± 1.5 | 68.4 ± 6.8 |
| Recovery (%) | 184.2 ± 19.7 | 103.4 ± 6.1 | 93.8 ± 15.6 |

Protein adsorption was calculated as the difference in the protein content in the feed and flow through by mass balance.

### Example 5

### Capture of Bulk Soy Whey Protein from a Pre-Treated Whey Process (PT)

The feed stream to the process, pre-treated whey protein, (also referred to PT whey) had approximately 1.4%-2.0% solids. It was comprised of approximately 18% minerals, 18% protein, and 74% sugars and other materials. Implementation of a Nanofiltration (NF) process allowed for water removal while retaining most of the sugars and protein, and other solid material, in the process to be recovered downstream. The NF membranes (Alfa Laval NF99 8038/48) for the trial were polyamide type thin film composite on polyester membranes with a 2 kDa molecular weight cutoff (MWCO) that allowed water, monovalent cations, and a very small amount of sugars and protein to pass through the pores. The membrane housing held 3 membrane elements. Each element was 8 inches in diameter and had 26.4 square meters of membrane surface area. The total membrane surface area for the process was 79.2 square meters. These membranes were stable up to 1 bar of pressure drop across each membrane element. For the entire module containing 3 membrane elements, a pressure drop of 3 bar was the maximum allowable. The NF feed rate of PT whey was approximately 2,500 L/hour. The temperature of this feed was approximately 45-50° C., and the temperature of the NF operation was regulated to be in this range using cooling water. Initial product flux rates were approximately 16-22 liters per meter squared per hour (LMH). The feed pressure at the inlet of the module was approximately 6 bar. Through the duration of the 6 hour run, the flux dropped as a result of fouling. The feed pressure was increased incrementally to maintain higher flux, but as fouling occurred, the pressure was increased to the maximum, and the flux slowly tapered from that point. Volumetric concentration factors were between 2× and approximately 4×.

A Precipitation step was performed to separate, e.g., phosphorous and calcium salts and complexes from the PT whey. Precipitation conditions were at pH 9 while maintaining the temperature at 45° C. with a residence time of approximately 15 minutes. The precipitation process occurred in a 1000 liter. This tank had multiple inlets and outlets where materials can be piped into and out of it. A small centrifugal pump circulated product out of the tank and back into the side of the tank to promote agitation and effective mixing of the 35% NaOH added to the system to maintain the target pH. This pump also sent product into the centrifuge when one of the T-valves connected to this recirculation loop was opened. Concentrated PT whey from the NF was fed directly into the top of the tank. 35% NaOH was connected into the feed line from the NF in order to control the pH at the target value. PT whey was fed into this mixing tank at approximately 2,500 L/hour and fed out at the same rate.

In following process step, an Alfa Laval Disc Centrifuge (Clara 80) with intermittent solids ejection system was used to separate precipitated solids (including insoluble soy fiber, insoluble soy protein) from the rest of the sugar- and protein-containing whey stream. In this process, concentrated PT whey from the precipitation tank was pumped into a disc-centrifuge where this suspension was rotated and accelerated by centrifugal force. The heavier fraction (precipitated solids) settles on the walls of the rotating centrifuge bowl with the lighter fraction (soluble liquid) was clarified through the use of disc-stacks and continuously discharged for the next step of the process. The separated precipitated solids was discharged at a regular interval (typically between 1 and 10 minutes). The clarified whey stream was less then 0.2% solids on a volumetric basis. The continuous feed flow rate was approximately 2.5 m3/hr, with a pH of 9.0 and 45° C. The insoluble fraction reached Ash=30-60%; Na=0.5-1.5% dry basis, K=1.5-3% dry basis, Ca=6-9% dry basis, Mg=3-6% dry basis, P=10-15% dry basis, Cl=1-2% dry basis, Fe, Mn, Zn, Cu<0.15% dry basis. Changes to the soluble fraction were as follows: Phytic acid was approximately 0.3% dry basis (85% reduction, P=0.2-0.3% dry basis (85-90% reduction), Ca=0.35-0.45% dry basis (80-85% reduction), Mg=0.75-0.85% dry basis (15-20% reduction).

The next step was an Ultrafiltration (UF) membrane. Protein was concentrated by being retained by a membrane while other smaller solutes pass into the permeated stream. From the centrifuge a diluted stream the containing protein, minerals and sugars was fed to the UF. The UF equipment and the membrane were supplied from Alfa Laval while the CIP chemicals came from Ecolab, Inc. The tested membrane, GR70PP/80 from Alfa-Laval, had a MWCO of 10 kD and was constructed of polyethersulfone (PES) cast onto a polypropylene polymer backing. The feed pressure varied throughout the trial from 1-7 bar, depending upon the degree of fouling of the membranes. The temperature was controlled to approximately 65° C. The system was a feed and bleed setup, where the retentate was recycled back to the feed tank while the permeate proceeded on to the next step in the process. The system was operated until a volume concentration factor of 30× was reached. The feed rate to the UF was approximately 1,600 L/hour. The setup had the ability to house 3 tubes worth of 6.3″ membrane elements. However, only one of the three tubes was used. The membrane skid had an automatic control system that allowed control of the temperature, operating pressures (inlet, outlet, and differential) and volume concentration factor during process. Once the process reached the target volume concentration factor, typically after 6-8 hours of operation, the retentate was diafiltered (DF) with one cubic meter of water, (approximately 5 parts of diafiltration water per part of concentrated retentate) to yield a high protein retentate. After a processing cycle, the system was cleaned with a typical CIP protocol used with most protein purification processes. The retentate contained about 80% dry basis protein after diafiltration.

The permeate of the UF/DF steps contained the sugars and was further concentrated in a Reverse Osmosis Membrane system (RO). The UF permeate was transferred to an RO system to concentrate the feed stream from approximately 2% total solids (TS) to 20% TS. The process equipment and membranes (RO98pHt) for the RO unit operation were supplied by Alfa-Laval. The feed pressure was increased in order to maintain a constant flux, up to 45 bar at a temperature of 50° C. Typically each batch started at a 2-3% Brix and end at 20-25% Brix (Brix=sugar concentration).

After the RO step the concentrated sugar stream was fed to an Electrodialysis Membrane (ED). Electrodialysis from Eurodia Industrie SA removes minerals from the sugar solution. The electrodialysis process has two product streams. One is the product, or diluate, stream which was further processed to concentrate and pasteurize the SOS concentrate solution. The other stream from the electrodialysis process is a brine solution which contains the minerals that were removed from the feed stream. The trial achieved >80% reduction in conductivity, resulting in a product stream that measured <3 mS/cm conductivity. The batch feed volume was approx 40 liters at a temperature of 40° C. and a pH of 7. The ED unit operated at 18V and had up to 50 cells as a stack size.

The de-mineralized sugar stream from the ED was further processed in an Evaporation step. The evaporation of the SOS stream was carried out on Anhydro's Lab E vacuum evaporator. SOS product was evaporated to 40-75% dry matter with a boiling temperature of approximately 50-55° C. and a ΔT of 5-20° C.

A Spray Dryer was used to dry UF/DF retentate suspension. The UF diafiltrate retentate, with a solids content of approximately 8%, was kept stirred in a tank. The suspension was then fed directly to the spray dryer where it was combined with heated air under pressure and then sprayed through a nozzle. The dryer removed the water from the suspension and generated a dry powder, which was collected in a bucket after it was separated from the air stream in a cyclone. The feed suspension was thermally treated at 150° C. for 9 seconds before it entered the spray dryer to kill the microbiological organisms. The spray dryer was a Production Minor from the company Niro/GEA. The dryer was set up with co-current flow and a two fluid nozzle. The drying conditions varied somewhat during the trial. Feed temperatures were about 80° C., nozzle pressure was about 4 bars, and inlet air temperatures was about 250° C.

### Example 6

### Capture of Bulk Soy Whey Protein Whey Pre-Treatment Process and Cross-Flow Filtration Membranes

Approximately 8000 lbs of aqueous soy whey (also referred to as raw whey) at 110° F. and 4.57 pH from an isolated soy protein extraction and isoelectric precipitation continuous process was fed to a reaction vessel where the pH was increased to 5.3 by the addition of 50% sodium hydroxide. The pH-adjusted raw whey was then fed to a second reaction vessel with a 10 minute average residence time in a continuous process where the temperature was increased to 190° F. by the direct injection of steam. The heated and pH-adjusted raw whey was then cooled to 90 degrees F. by passing through a plate and frame heat exchanger with chilled water as the cooling medium. The cooled raw whey was then fed into an Alfa Laval VNPX510 clarifying centrifuge where the suspended solids, predominantly insoluble large molecular weight proteins, were separated and discharged in the underflow to waste and the clarified centrate proceeded to the next reaction vessel. The pH of the clarified centrate, or pre-treated whey protein, was adjusted to 8.0 using 12.5% sodium hydroxide and held for 10 minutes prior to being fed into an Alfa Laval VNPX510 clarifying centrifuge where the suspended solids, predominantly insoluble minerals, were separated and discharged in the underflow to waste. The clarified centrate proceeded to a surge tank prior to ultrafiltration. Ultrafiltration of the clarified centrate proceeded in a feed and bleed mode at 90° F. using 3.8″ diameter polyethersulfone spiral membranes, PW3838C, made by GE Osmonics, with a 10 kDa molecular weight cut-off. Ultrafiltration continued until a 60× concentration of the initial feed volume was accomplished, which required about 4.5 hrs. The retentate, 114 lbs at 4.5% total solids and 8.2 pH, was transferred to a reaction vessel where the pH was adjusted to 7.4 using 35% hydrochloric acid. The retentate was then heated to 305° F. for 9 seconds via direct steam injection prior to flash cooling to 140° F. in a vacuum chamber. The material was then homogenized by pumping through a homogenizing valve at 6000 psi inlet and 2500 outlet pressure prior to entering the spray drier through a nozzle and orifice combination in order to atomize the solution. The spray drier was operated at 538° F. inlet temperature and 197° F. outlet temperature, and consisted of a drying chamber, cyclone and baghouse. The spray dried soy whey protein, a total of 4 lbs, was collected from the cyclone bottom discharge.

### Example 7

### Capture of Bulk Soy Whey Protein Using Expanded Bed Adsorption (EBA) Chromatography

200 ml of aqueous raw soy whey (not pre-treated) with a total solids content of 1.92%, was adjusted to pH 4.5 with acetic acid and applied to a 1×25 cm column of Mimo6ME resin (UpFront Chromatography, Copenhagen Denmark) equilibrated in 10 mM sodium citrate, pH 4.5. Material was loaded onto the column from the bottom up at 20-25° C. using a linear flow rate of 7.5 cm/min. Samples of the column flow-through were collected at regular intervals for later analysis. Unbound material was washed free of the column with 10 column volumes of equilibration buffer, then bound material recovered by elution with 50 mM sodium hydroxide. 10 μls of each fraction recovered during EBA chromatography of aqueous soy whey were separated on a 4-12% SDS-PAGE gel and stained with Coomassie Brilliant Blue R 250 stain. SDS-PAGE analysis of the column load, flow-through, wash, and sodium hydroxide eluate samples is depicted in FIG. 12. As used in FIG. 12, RM: raw material (column load); RT1-4: column flow-through (run through) collected at equal intervals during the load; total: the total run-through fraction; W: column wash; E: column eluate. Binding was reasonably efficient, as very little protein is seen in the initial breakthrough fractions, only showing up in the later fractions. A total of 662 mg of protein was recovered in the eluate, for a yield of 3.3 mg/ml of starting material. Under these conditions, the capacity of this resin was shown to be 33.1 mg of protein per ml of adsorbent.

### Example 8

### Capture of Bulk Soy Whey Protein from Spray-Dried SWP Using Expanded Bed Adsorption (EBA) Chromatography

Spray-dried soy whey powder was slurried to a concentration of 10 mg/ml in water and adjusted to pH 4.0 with acetic acid. 400 ml of the slurry was then applied directly to the bottom of a 1×25 cm column of Mimo-4SE resin (UpFront Chromatography, Copenhagen Denmark) that had been equilibrated in 10 mM sodium citrate, pH 4.0. Material was loaded at 20-25° C. using a linear flow rate of 7.5 cm/min. Samples of the column flow-through were collected at regular intervals for later analysis. Unbound material was washed free of the column using 10 column volumes of equilibration buffer. Bound material was eluted with 30 mM NaOH. 10 μls of each fraction recovered during EBA chromatography of a suspension of soy whey powder were separated on a 4-12% SDS-PAGE gel and stained with Coomassie Brilliant Blue R 250 stain. SDS-PAGE analysis of the column load, flow-thru, wash, and eluate are depicted in FIG. 13. As used in FIG. 13, RM: raw material (column load); RT1-4: column flow-through (run through) collected at equal intervals during the load; total: the total run-through fraction; W: column wash; E: column eluate. Binding was not as efficient as was observed using the Mimo6ME resin, as several protein bands are seen in the breakthrough fractions. A total of 2070 mg of protein were recovered in the eluate, for a yield of 5.2 mg/ml of starting material. Under these conditions, the capacity of this resin was shown to be 104 mg of protein per ml of adsorbant.

### Example 9

### Removal of KTI from Bulk Soy Whey Protein Using Expanded Bed Adsorption (EBA) Chromatography

Two procedures were used to remove the majority of contaminating KTI protein from the bulk of the soy whey protein by EBA chromatography. In the first, 200 ml of aqueous raw soy whey (not pre-treated) with a total solids content of 1.92%, was adjusted to pH 6.0 with sodium hydroxide and applied to a 1×25 cm column of Mimo6HE resin (UpFront Chromatography, Copenhagen Denmark) equilibrated in 10 mM sodium citrate, pH 6.0. Material was loaded onto the column from the bottom up at 20-25° C. using a linear flow rate of 7.5 cm/min. Samples of column flow-through were collected at regular intervals for later analysis. Unbound material was washed free of the column with 10 column volumes of equilibration buffer, then bound material recovered by elution with 30 mM sodium hydroxide. 10 μls of each fraction recovered during EBA chromatography of a suspension of soy whey powder were separated on a 4-12% SDS-PAGE gel and stained with Coomassie Brilliant Blue R 250 stain. SDS-PAGE analysis of the column load, flow-through, wash, and sodium hydroxide eluate samples is depicted in FIG. 14. As used in FIG. 14, RM: raw material (column load); RT1-4: flow-through material (run through) collected at equal intervals during the load; total: the total run-through fraction; W: column wash; E: column eluate. The bulk of the loaded protein is clearly seen eluting in the flow-through, while the bulk of the KTI protein remains bound to the resin. A total of 355 mg of protein, the bulk of which is KTI, was recovered in the eluate, for a yield of 1.8 mg/ml of starting material. Under these conditions, the capacity of this resin was shown to be 17.8 mg of KTI (plus minor contaminants) per ml of adsorbent.

In the second procedure, 160 mls of aqueous raw soy whey (not pre-treated) with a total solids content of 1.92%, was adjusted to pH 5.1 with acetic acid and applied to a 1×25 cm column of Mimo6ZE resin (UpFront Chromatography, Copenhagen Denmark) equilibrated in 10 mM sodium citrate, pH 5.0. Material was loaded onto the column from the bottom up at 20-25° C. using a linear flow rate of 7.5 cm/min. Samples of column flow-through were collected at regular intervals for later analysis. Unbound material was washed free of the column with 10 column volumes of equilibration buffer, then bound material recovered by elution with 30 mM sodium hydroxide. 10 μls of each fraction recovered during EBA chromatography of a suspension of soy whey powder were separated on a 4-12% SDS-PAGE gel and stained with Coomassie Brilliant Blue R 250 stain. SDS-PAGE analysis of the column load, flow-through, wash, and sodium hydroxide eluate samples is depicted in FIG. 15. As used in FIG. 15, RM: raw material (column load); RT1-4: flow-through material (run through) collected at equal intervals during the load; total: the total run-through fraction; W: column wash; E: column eluate. The bulk of the KTI is clearly seen eluting in the flow-through, while the bulk of the remaining protein remains bound to the resin. A total of 355 mg of soy protein essentially devoid of contaminating KTI was recovered in the eluate, for a yield of 2.1 mg/ml of starting material. Under these conditions, the capacity of this resin was shown to be 16.8 mg of soy protein per ml of adsorbent.

### Example 10

### Formation of a White Sauce Containing an Emulsifying Agent Comprised of an Amount of Soy Whey Protein

A basic white sauce was prepared using an emulsifying agent comprised of soy whey protein as described hereinabove. Table 9 is the list of ingredients used to prepare a variety of white sauces having an emulsifying agent comprised of differing amounts and combinations of whey protein concentrate (WPC) and soy whey protein (SWP).

TABLE 9
White Sauce Formulation with an Emulsifying Agent Comprised of Soy Whey Protein

| | | | 2.50% WPC + | | | | 2.50% WPC + | |
|---|---|---|---|---|---|---|---|---|
| | 0.25% SWP | | 0.25% SWP | | 2.50% SWP | | 2.50% SWP | |
| Ingredient | % | Gms | % | Gms | % | Gms | % | Gms |
| Tap | 77.55 | 3877.00 | 75.05 | 3752.50 | 75.30 | 3765.00 | 72.80 | 3640.00 |
| Water | | | | | | | | |
| Unsalted | 11.00 | 550.00 | 11.00 | 550.00 | 11.00 | 550.00 | 11.00 | 550.00 |
| Butter | | | | | | | | |
| WPC | 0.00 | 0.00 | 2.50 | 125.00 | 0.00 | 0.00 | 2.50 | 125.00 |
| Flour (all | 7.00 | 350.00 | 7.00 | 350.00 | 7.00 | 350.00 | 7.00 | 350.00 |
| purpose) | | | | | | | | |
| Modified | 2.70 | 135.00 | 2.70 | 135.00 | 2.70 | 135.00 | 2.70 | 135.00 |
| Starch | | | | | | | | |
| Soy | 0.25 | 12.50 | 0.25 | 12.50 | 2.50 | 125.00 | 2.50 | 125.00 |
| whey | | | | | | | | |
| protein | | | | | | | | |
| Salt | 0.97 | 48.50 | 0.97 | 48.50 | 0.97 | 48.50 | 0.97 | 48.50 |
| Methyl | 0.50 | 25.00 | 0.50 | 25.00 | 0.50 | 25.00 | 0.50 | 25.00 |
| cellulose | | | | | | | | |
| Ground | 0.03 | 1.50 | 0.03 | 1.50 | 0.03 | 1.50 | 0.03 | 1.50 |
| white | | | | | | | | |
| pepper | | | | | | | | |
| Total | 100.00 | 5000.00 | 100.00 | 5000.00 | 100.00 | 5000.00 | 100.00 | 5000.00 |

The basic white sauce was formed by first heating the water in a suitable container, such as a Groen TDC/3-20 kettle (Groen, Jackson, Miss.), to a temperature of approximately 25° C. The protein was added to the water, mixed with a mixer (such as an Arrow Engineering A-5 mixer) under sufficient agitation until the protein was completely dispersed, and then heated to a temperature of 82° C. The protein slurry was held for 10 minutes at this temperature. Starch was then added to the protein slurry with good shear mixing for 5 minutes.

The butter was melted in a second container (such as a Groen TDC/3-20 kettle). In a third container (e.g., a Groen TDC/3-20 kettle), the remaining dry ingredients (flour, stabilizer, salt and pepper) were mixed well, and slowly/constantly added into the melted butter. The melted butter/flour mixture was heated slowly to a temperature of 80° C. and held for 15 seconds. The melted butter/flour mixture was added to the protein slurry and mixed well. The last step was to homogenize the white sauce. Homogenization was completed at standard industry settings (500 psi (34.47 BAR), 2nd stage; 2500 psi (172.36 BAR) 1st stage) using an APV 15 MR. Homogenizer (SPX, Charlotte, N.C.).

The sauce was transferred to suitable containers for hot fill and placed in an ice bath until the temperature of the white sauce reached near room temperature.

The white sauce samples that were prepared with an emulsifying agent comprised of various amounts of soy whey protein retained the same sensory properties (e.g., taste, structure, aroma, and mouthfeel) of typical white sauces currently in the market.

### Example 11

### Formation of a Mayonnaise Containing an Emulsifying Agent Comprised of an Amount of Soy Whey Protein

A mayonnaise was prepared using an emulsifying agent comprised of soy whey protein as described hereinabove. Table 10 is the list of ingredients used to prepare a mayonnaise having an emulsifying agent comprised of varying amounts of soy whey protein (SWP), compared to a mayonnaise prepared without proteins.

TABLE 10
Mayonnaise Formulation with an Emulsifying Agent Comprised
of Soy Whey Protein Compared to Mayonnaise without an
Emulsifying Agent Comprised of Soy Whey Protein

| | | | 2.00% | | 4.00% |
|---|---|---|---|---|---|
| | | Negative | Soy Whey | 50:50 Egg | Soy Whey |
| Ingredients | Control | Control | Protein | Yolk/SWP | Protein |
| Tap water | 45.49 | 49.69 | 47.69 | 46.59 | 45.69 |
| Oil | 30.00 | 30.00 | 30.00 | 30.00 | 30.00 |
| Vinegar, 50 | 9.80 | 9.80 | 9.80 | 9.80 | 9.80 |
| grain | | | | | |
| Food starch | 5.00 | 5.00 | 5.00 | 5.00 | 5.00 |
| Sugar | 2.50 | 2.50 | 2.50 | 2.50 | 2.50 |
| Egg Yolk | 4.20 | 0.00 | 0.00 | 2.10 | 0.00 |
| Soy whey | 0.00 | 0.00 | 2.00 | 1.00 | 4.00 |
| protein | | | | | |
| Salt | 1.90 | 1.90 | 1.90 | 1.90 | 1.90 |
| Lemon juice | 0.75 | 0.75 | 0.75 | 0.75 | 0.75 |
| Mustard | 0.30 | 0.30 | 0.30 | 0.30 | 0.30 |
| flour | | | | | |
| Potassium | 0.06 | 0.06 | 0.06 | 0.06 | 0.06 |
| sorbate | | | | | |
| Total | 100.00 | 100.00 | 100.00 | 100.00 | 100.00 |

The mayonnaise was formed by first dispersing potassium sorbate in cold tap water in a process tank (a Groen TDC/3-20 kettle) with a recirculation pump. A colloid mill, a Baldor BV-31 (Baldor Electric Company, Fort Smith, Ark.) was connected into the circuit unit to complete the dispersion. The protein was dispersed with water and continued circulating for 1 minute to complete dispersion and hydration of the protein.

A dry blend of starch, sugar and mustard were dispersed with the protein slurry and continuously circulated through the recirculation pump and colloid mill for 6 minutes to achieve a smooth consistency. Salt, vinegar and lemon juice were dispersed with the mixture and circulated for 2 minutes to mix well. The oil was added slowly to the mixture to obtain a smooth and creamy emulsion having a pH of less than 3.9 (target pH).

FIG. 16 depicts the five samples that were made using different emulsifiers: Sample 1—egg yolk only (control), Sample 2—no emulsifier (negative control); Sample 3—2% soy whey protein, Sample 4—2.1% egg yolk/1% soy whey protein, and Sample 5—4% soy whey protein. Mayonnaise was diluted to 10% oil-in-water (o/w) emulsion by adding water, vinegar, lemon, and salt. 10% o/w emulsions contained 1.33% (protein weight/mayonnaise weight) protein and 10% fat, as shown in FIG. 17. Smaller fat globules are dynamically more stable thus the SWP provided better emulsion and stability in the mayonnaise system.

The mayonnaise samples prepared with an emulsifying agent comprised of soy whey protein (Samples 3, 4, and 5 in FIG. 16) were evaluated against the mayonnaise sample comprised of emulsifying agent without soy whey protein (egg yolks), as well as a negative control that did not comprise an emulsifying agent. See Samples 1 and 2, respectively in FIG. 16. The mayonnaise samples that were prepared with an emulsifying agent comprised of various amounts and combinations of soy whey protein (Samples 3, 4, and 5) all retained the same sensory properties (e.g., taste, structure, aroma, and mouthfeel) of typical mayonnaise products currently in the market.

### Example 12

### Formation of Spreadable Margarine Containing an Emulsifying Agent Comprised of an Amount of Soy Whey Protein

A margarine product was prepared using an emulsifying agent comprised of soy whey protein as described hereinabove. Table 11 is the list of ingredients used to prepare a spreadable margarine having an emulsifying agent comprised of various amounts of soy whey protein (SWP).

TABLE 11
Preparation of a Spreadable Margarine Formulation with
an Emulsifying Agent Comprised of Soy Whey Protein

Soy Whey Protein

| Ingredients | % | Gms |
|---|---|---|
| Oil Phase | | |
| Palm Oil | 53.48 | 401.10 |
| Coconut Oil | 3.00 | 22.50 |
| Soybean Oil | 23.52 | 176.40 |
| Soy Whey Protein | 2.00 | 15.00 |
| Aqueous Phase | | |
| Water | 16.10 | 120.75 |
| Salt | 1.80 | 13.50 |
| Non-Fat Dry Milk | 0.10 | 0.75 |
| Total | 100.00 | 750.00 |

The spreadable margarine was prepared by first preparing the aqueous phase in a water phase tank (a Groen TDC/3-20 kettle). The aqueous phase components (water, salt, and non-fat dry milk) were combined together with a mixer, an Arrow Engineering A-5 mixer (Arrow Engineering, Hillside, N.J.) in the tank and heated to a temperature of 65.6° C. The mixture was held at this temperature for 30 minutes.

The oil phase was prepared by melting and mixing the oils, soy whey protein, color and flavors in an emulsion fat tank (a second Groen TDC/3-20 kettle). When all the ingredients in the oil phase were mixed well, the aqueous phase mixture was added to the emulsion fat tank and the emulsion was created. The emulsion was pumped through crystallization equipment, a Waukesha Cherry Burrell Votator® (Waukesha Cherry Burrell, Delavan, Wis.), sub-cooled, and crystallization was allowed to take place to form a margarine product.

The spreadable margarine product that was prepared with soy whey protein as the emulsifier retained the same sensory properties (e.g., taste, structure, aroma, and mouthfeel) of typical margarine products currently in the market.

### Example 13

### Formation of a Bread Product Containing an Emulsifying Agent Comprised of an Amount of Soy Whey Protein

A bread was prepared using an emulsifying agent comprised of soy whey protein as described hereinabove. Table 12 is the list of ingredients used to prepare a bread having an emulsifying agent comprising 0.25% soy whey protein (SWP).

TABLE 12
Preparation of a Bread Formulation with an Emulsifying
Agent Comprised of Soy Whey Protein

Soy Whey Protein

| Ingredients | % | Gms |
|---|---|---|
| SPONGE | | |
| White bread flour | 70.000 | 770.000 |
| Instant yeast | 1.300 | 14.300 |
| Soybean oil | 2.000 | 22.000 |
| Ascorbic Acid | 0.370 | 4.100 |
| Solution (20 ppm) | | |
| Water | 40.230 | 442.500 |
| Sponge Total: | | 1252.900 |
| Sponge Absorption: | | 58.000 |
| DOUGH | | |
| White bread | 30.00 | 330.00 |
| flour | | |
| Soy Whey | 0.250 | 2.800 |
| Protein | | |
| Salt | 2.000 | 22.000 |
| Calcium | 0.350 | 3.900 |
| propionate | | |
| Instant yeast | 0.700 | 7.700 |
| HFCS - 42 | 12.000 | 132.000 |
| Ascorbic acid | 1.100 | 12.100 |
| solution | | |
| (60 ppm) | | |
| Water | 12.400 | 136.400 |

| | |
|---|---|
| Dough Side Total: | 646.800 |
| Formula Total: | 1899.700 |
| Total Flour: | 1100.000 |
| Total Absorption: | 57.780 |

The bread dough was prepared by first adding all of the sponge ingredients to a mixing bowl, a Hobart A-200 mixer with a McDuffie Bowl attachment (Hobart Corp., Troy, Ohio). All of the sponge ingredients were mixed on speed 1 for 1 minute, then on speed 2 for 2 minutes. The target temperature for the sponge was 25.6° C.

The sponge was fermented for 3 hours at 35° C./85% relative humidity (RH). The target temperature for the sponges after fermentation was 30° C. to 31° C.

The dough ingredients were combined in a separate mixing bowl and mixed on speed 1 for about 30 seconds. The sponge mixture was then added to the dough mixture. The combination was mixed on speed 1 for 1 minute, then on speed 2 to optimum dough development (about 8-10 minutes). The temperature target of the dough was about 25.6° C. (±1° C.).

The dough was then covered and placed on a surface for a 5 minute floor rest time. The dough was then scaled (divided) into 19.5 ounce (552.8 gram) pieces. The dough pieces were rounded and covered and left to rest for 5 minutes. The dough pieces where then placed into pans measuring about 7⅞″×4¼″×3″. The pans were placed into a 221° C. a Metro C5 3 Series oven (Metro Supply and Equipment, Alton, Ill.) for 18-22 minutes. When done, the pans were removed from the oven and placed on a wire rack for about 1 hour to cool. The cooled loaves were then bagged.

FIG. 18 depicts the bread sample prepared with an emulsifying agent comprised of soy whey protein (0.250% SWP). The bread sample that was prepared with an emulsifying agent comprised of soy whey protein retained the same sensory properties (e.g., appearance, taste, structure, aroma, and mouthfeel) of typical bread products currently in the market.

### Example 14

### Formation of a Fat Powder Containing an Emulsifying Agent Comprised of an Amount of Soy Whey Protein

A fat powder was prepared using an emulsifying agent comprised of soy whey protein as described hereinabove. Table 13 is the list of ingredients used to prepare a fat powder having an emulsifying agent comprised of varying amounts of soy whey protein (SWP).

TABLE 13
Preparation of a Fat Powder Formulation with an
Emulsifying Agent Comprised of Soy Whey Protein

SWP

| Ingredients | % | Weight (g) |
|---|---|---|
| Distilled Water | 49.20 | 3269.00 |
| Palm Oil | 17.50 | 1225.00 |
| Soybean Oil | 14.82 | 1223.11 |
| Stabilizing Agent | 0.18 | 1.89 |
| 25DE Corn Syrup | 15.00 | 1050.00 |
| Solids | | |
| Sodium Caseinate | 2.50 | 175.00 |
| Dipotassium | 0.30 | 21.00 |
| phosphate | | |
| Soy whey protein | 0.50 | 35.00 |
| Total | 100.00 | 7000.00 |

The fat powder was prepared by first heating the palm oil to melting point in a mixing tank (a Groen TDC/3-20 kettle). The soybean oil was added to the melted palm oil and mixed with a mixer (an Arrow Engineering A-5 mixer) until well blended.

In a second tank, the water and dipotassium phosphate were added together and mixed until dissolved. The water was then heated to a temperature of 60° C. The sodium caseinate and soy whey protein were then added to the potassium phosphate solution and the protein slurry was heated to a temperature of 70° C. for a period of 10-15 minutes in order to hydrate the protein. The carbohydrates were added to the protein slurry and mixed until well dissolved.

The oil mixture was then added to the protein slurry and the mixture was combined thoroughly. This formed an emulsion. Once completely mixed together, the mixture was then homogenized at 150 BAR (2200 psi) using an APV 15 MR. Homogenizer. The mixture (emulsion) was then pumped to the nozzle of a spray dryer using a peristaltic pump, the spray dryer operating at 190° C. inlet temperature and 80° C. outlet temperature. The resultant fat powder was collected in suitable jars and transferred to a plastic bag to cool. Once cooled, the fat powder was stored in a refrigerator.

FIG. 19 depicts the fat powder sample prepared with an emulsifying agent comprised of soy whey protein (0.50% SWP). The fat powder sample that was prepared with an emulsifying agent comprised of with soy whey protein retained the same sensory properties (e.g., appearance, taste, structure, aroma, and mouthfeel) of fat powder products currently in the market.

### Example 15

### Formation of an Industrial Margarine Containing an Emulsifying Agent Comprised of an Amount of Soy Whey Protein

An industrial margarine was prepared using an emulsifying agent comprised of an amount of soy whey protein as described herein below. Table 14 is the list of ingredients that were used to prepare an industrial margarine having an emulsifying agent comprised of 75% soy whey protein (SWP) and 25% other emulsifiers.

TABLE 14
Preparation of an Industrial Margarine with an
Emulsifying Agent Comprised of Soy Whey Protein

| | 75% SWP + 25% other emulsifiers | |
|---|---|---|
| Ingredients | % | Kg |
| Oil Phase | | |
| Palm Oil | 53.480 | 21.927 |
| Hydrogenated Cottonseed Oil | 3.000 | 1.230 |
| Soybean Oil | 23.520 | 9.643 |
| Soy lecithin | 0.250 | 0.205 |
| Mono & Diglycerides | 0.250 | 0.205 |
| SWP | 1.500 | 0.410 |
| Color | 0.100 | 0.041 |
| Flavor-Butter flavor | 0.100 | 0.041 |
| Aqueous phase | | |
| Water | 15.890 | 6.515 |
| Salt | 1.800 | 0.738 |
| Nonfat Dry Milk | 0.100 | 0.041 |
| EDTA | 0.010 | 0.004 |
| Total | 100.000 | 41.000 |

The aqueous phase was prepared by combining the aqueous phase ingredients in an aqueous phase tank and heating the mixture to a temperature of 65.6° C. The mixture was held at the elevated temperature for a period of 30 minutes.

The oil phase was prepared by melting and mixing all of the oils together in an emulsion fat tank. The emulsifiers, lecithin, color and flavors were added to the oil mixture and mixed well. After all of the ingredients in the oil phase were combined, the aqueous phase mixture was added to the oil phase mixture in the emulsion fat tank to create the emulsion. The emulsion was pumped through the crystallization equipment, the emulsion was sub cooled, and allowed to crystallize.

The industrial margarine sample prepared with an emulsifying agent comprised of an amount of soy whey protein had the same functional and physical/chemical characteristics compared to an industrial margarine product currently in the market.

### Example 16

### Formation of a Ready to Drink Acid Beverage Containing an Emulsifying Agent Comprised of an Amount of Soy Whey Protein

A RTD-A beverage product can be prepared using an emulsifying agent comprised of an amount of soy whey protein (SWP) recovered from a soy processing stream as described hereinabove, in accordance with the process described below. Table 15 is the list of ingredients in the RTD-A beverage product having an emulsifying agent comprised of an amount of soy whey protein. The amounts are expressed in both concentration (%) and weight (grams).

TABLE 15
Preparation of a Ready to Drink Acid Beverage Product
with an Emulsifying Agent Comprised of Soy Whey Protein

SWP

| Ingredients | % | Gms |
|---|---|---|
| Water | 89.50 | 4475.00 |
| Sugar | 6.00 | 300.00 |
| SWP | 2.00 | 100.00 |
| Citrus Oils | 0.50 | 25.00 |
| Flavouring | 0.20 | 10.00 |
| Acid #1* | 1.06 | 53.00 |
| Acid #2** | 0.74 | 37.00 |
| Total | 100.00 | 5000.00 |

*Acid #1 is a solution of Citric acid (control sample) or 50% solution 75:25 blend of Malic acid:Citric acid
**Acid #2 is 85% phosphoric acid

To prepare the RTD-A beverage, the formula water is weighed, heated to approximately 25° C. and transferred to a conventional food processing kettle such as a stainless steel jacketed kettle equipped with air operated propeller mixer.

The soy whey protein is blended 1:1 with the sugar and then added to the water with continuous stirring. The protein and sugar are mixed for 20 minutes in the water with good shear to fully disperse the proteins and sugar to form a protein slurry. The rest of the sugar is added, then the oils and flavorings are added to the protein slurry and mixing is continued for approximately 5 minutes. The pH of the combined mixture is checked and first adjusted to a pH of 3.6 (+/−0.05) using a 50% solution of a 75:25 blend of Malic:Citric acid solution (Acid #1). The pH is again checked and further adjusted to a pH of 3.0-3.1 using an 85% phosphoric acid solution (Acid #2).

The mixture is heated to 65.6° C. (150° F.) for processing and transferred to Ultra High Temperature (UHT) processing. A UHT process is used at 124° C. (255° F.) for 8 seconds.

The mixture is then homogenized using a piston-type, 2 stage homogenizer set with 500 psi (34 BAR) pressure on the second stage and 2500 psi (138 BAR) pressure on the first stage at 3000 psi (207 BAR). The homogenized mixture is returned to the batch kettle. The mixture is then pasteurized at a temperature of 85° C. for 15 seconds.

The samples are heated to approximately 85° C. and filled into bottles suited for hot filling. The filled bottles placed on their sides and held in that position for approximately 3 minutes, rotating once at 1.5 minutes. The bottles are then cooled to room temperature in an ice bath and refrigerated until evaluation.

The RTD-A beverage made by the method described above will have an increased amount of protein and lower viscosity, while retaining the aroma and appearance of typical flavored RTD-A products currently on the market. Further, the use of the soy whey protein as an emulsifying agent will provide added stability for the cloud that is formed with the citrus oils in this example.

### Example 17

### Determination of SSI

A sample of the protein material is obtained by accurately weighing out 12.5 g of protein material. 487.5 g of deionized water is added to a quart blender jar. 2 to 3 drops of defoamer (Dow Corning (Dow Corning, Midland, Mich.) Antifoam B Emulsion, 1:1 dilution with water) is added to the deionized water in the blender jar. The blender jar containing the water and defoamer is placed on a blender (Osterizer (Jarden Consumer Solutions, Boca Raton, Fla.)), and the blender stirring speed is adjusted to create a moderate vortex (about 14,000 rpm). A timer is set for 90 seconds, and the protein sample is added to the water and defoamer over a period of 30 seconds while blending. Blending is continued for the remaining 60 seconds after addition of the protein sample (total blending time should be 90 seconds from the start of addition of the protein sample).

The resulting protein material sample/water/defoamer slurry is then transferred to a 500 ml beaker containing a magnetic stirring bar. The beaker is then covered with plastic wrap or aluminum foil. The covered beaker containing the slurry is then placed on a stirring plate, and the slurry is stirred at moderate speed for a period of 30 minutes.

200 g of the slurry is then transferred into a centrifuge tube. A second 200 g sample of the slurry is then transferred into a second centrifuge tube. The remaining portion of the slurry in the beaker is retained for measuring total solids. The 2 centrifuge tube samples are then centrifuged at 500×g for 10 minutes (1500 rpm on an IEC Model K (Thermo Scientific, Waltham, Mass.)). At least 50 ml of the supernatant is withdrawn from each centrifuge tube and placed in a plastic cup (one cup for each sample from each centrifuge tube, 2 total cups).

Soluble Solids is then determined by drying a 5 g sample of each supernatant at 130° C. for 2 hours, measuring the weights of the dried samples, and averaging the weights of the dried samples.

Total Solids is determined by drying two 5 g samples of the slurry retained in the beaker, measuring the weights of the dried samples, and averaging the weights of the dried samples.

The Soluble Solids Index (SSI) is calculated from the Soluble Solids and Total Solids according to the formula (Soluble Solids/Total Solids)×100.

One skilled in the art would readily appreciate that the methods, compositions, and products described herein are representative of exemplary embodiments, and not intended as limitations on the scope of the invention. It will be readily apparent to one skilled in the art that varying substitutions and modifications may be made to the present disclosure disclosed herein without departing from the scope and spirit of the invention.

All patents and publications mentioned in the specification are indicative of the levels of those skilled in the art to which the present disclosure pertains. All patents and publications are herein incorporated by reference to the same extent as if each individual publication was specifically and individually indicated as incorporated by reference.

The present disclosure illustratively described herein suitably may be practiced in the absence of any element or elements, limitation or limitations that are not specifically disclosed herein. Thus, for example, in each instance herein any of the terms “comprising,” “consisting essentially of,” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the present disclosure claimed. Thus, it should be understood that although the present disclosure has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. An emulsifying agent comprising an amount of soy whey protein.

2. The emulsifying agent of claim 1, wherein the soy whey protein has a SSI of at least about 80% across a pH range of from 2 to 10 and a temperature of 25° C.

3. The emulsifying agent of claim 1, wherein the emulsifying agent comprises 100% by weight of soy whey protein.

4. The emulsifying agent of claim 1 wherein the emulsifying agent is effective in a pH range of from about 2.0 to about 10.0.

5. The emulsifying agent of claim 1, further comprising at least one additional emulsifier.

6. The emulsifying agent of claim 5, wherein the at least one additional emulsifier is selected from the group consisting of mono- and diglycerides of fatty acids, esters of monoglycerides of fatty acids, diacetyl tartaric acid ester of mono- and diglycerides (DATEM), propylene glycol monoesters, lecithin, hydroxylated lecithin, dioctyl sodium sulphosuccinate, sodium stearoyl-2-lactylate (SSL), calcium stearoyl lactylate (CSL), sorbitan monolaurate (Polysorbate 20), sorbitan monopalmitate (Polysorbate 40), sorbitan monostearate (Polysorbate 60), sorbitan monooleate (Polysorbate 80), sorbitan tristearate, stearyl citrate, and polyglycerol polyricinoleate (PGPR), caseinate, and combinations thereof.

7. The emulsifying agent of claim 5, wherein the emulsifying agent comprises between about 5% and about 99.9% by weight of soy whey protein.

8. The emulsifying agent of claim 5, wherein the at least one additional emulsifying agent is diacetyl tartaric acid ester of mono- and diglycerides (DATEM).

9. The emulsifying agent of claim 1, wherein the molecular weight of the soy whey protein is between about 8 kDa and about 50 kDa.

10. A food product comprising the emulsifying agent of claim 1.

11. The food product of claim 10, which is a dessert product.

12. The food product of claim 11, wherein the dessert product is selected from the group consisting of pudding, confections, chocolate, fondant, cakes, frozen confection, frozen desserts, and combinations thereof.

13. The food product of claim 10, which is a sauce product.

14. The food product of claim 13, wherein the sauce product is selected from the group consisting of ready made sauces, salad sauces, pan sauces, vegetable sauces, dessert sauces, chocolate sauces, caramel sauces, white sauces, brown sauces, emulsified sauces, sweet sauces, fruit sauces, jellies, jams, preserves, chutney, compotes, apple sauce, puddings, gelatin, molè sauces, remoulades, sauce bases, such as espangole, veloutè, Béchamel, Hollandaise, cheese sauces, salsas, relishes, cooked sauces, and combinations thereof.

15. The food product of claim 10, which is a spread product.

16. The food product of claim 15, wherein the spread product is selected from the group consisting of cheese spreads, cream spreads, mayonnaise, salad dressings, spreadable oils, nut butters, fruit butters, and combinations thereof.

17. The food product of claim 10, which is a soup product.

18. The food product of claim 17, wherein the soup product is selected from the group consisting of ready-to-eat soups, canned condensed soups, broths, cream soups, bisques, chowders, purees, meat soups, vegetable soups, soups, cold soups, dessert soups, seafood soups, beverage soups fermented soups, ready-to-serve soups, clear soups, thick soups, soups with particulates, chilled soups, and combinations thereof.

19. The food product of claim 10, which is a beverage product.

20. The food product of claim 19, wherein the beverage product is selected from the group consisting of milk beverages, juice refresher beverages, milk shake beverages, smoothie beverages, ready to drink beverages (neutral and acid), and combinations thereof.

21. The food product of claim 10, wherein the emulsifying agent is present in the food product in an amount from about 0.01% to about 5% by weight of the food product.

22. The food product of claim 21, wherein the emulsifying agent is present in the food product in an amount from about 0.01% to about 3% by weight of the food product.

23. The food product of claim 22, wherein the emulsifying agent is present in the food product in an amount from about 0.01% to about 2% by weight of the food product.

24. A food product comprising an emulsifying agent, wherein the emulsifying agent comprises an amount of soy whey protein.

25. The food product of claim 24, wherein the food product further comprises at least one additional emulsifier.

26. The food product of claim 25, wherein the at least one additional emulsifier is selected from the group consisting of mono- and diglycerides of fatty acids, esters of monoglycerides of fatty acids, diacetyl tartaric acid ester of mono- and diglycerides (DATEM), propylene glycol monoesters, lecithin, hydroxylated lecithin, dioctyl sodium sulphosuccinate, sodium stearoyl-2-lactylate (SSL), calcium stearoyl lactylate (CSL), sorbitan monolaurate (Polysorbate 20), sorbitan monopalmitate (Polysorbate 40), sorbitan monostearate (Polysorbate 60), sorbitan monooleate (Polysorbate 80), sorbitan tristearate, stearyl citrate, and polyglycerol polyricinoleate (PGPR), caseinate, and combinations thereof.

27. The food product of claim 24, wherein the food product further comprises an ingredient selected from the group consisting of protein-containing material, carbohydrates, stabilizers, pH-adjusting agents, dairy products, preservatives, flavoring agents, sweetening agents, coloring agents, nutrients, and combinations thereof.

28. A method of making a food product comprising an emulsifying agent, the method comprising the steps of:
(1) combining the emulsifying agent with at least two immiscible substances to form an emulsion; and
(2) processing the emulsion into the desired food product,
wherein the emulsifying agent comprises an amount of soy whey protein.

29. The method of claim 28, wherein the emulsifying agent further comprises at least one additional emulsifier.

30. The method of claim 28, further comprising adding to the emulsion an additional ingredient selected from the group consisting of protein-containing material, carbohydrates, stabilizers, dairy products, pH-adjusting agents, preservatives, flavoring agents, sweetening agents, coloring agents, nutrients, and combinations thereof.

31. The method of claim 28, wherein the emulsifying agent is present in the food product in an amount of from between about 0.01% and about 5% by weight.

32. The method of claim 28, wherein the food product is selected from the group consisting of a dessert, sauce, spread, soup, beverage, and combinations thereof.

33. A stabilizing and emulsifying agent comprising an amount of soy whey protein.

34. The stabilizing and emulsifying agent of claim 33, wherein the soy whey protein has a SSI of at least about 80% across a pH range of from 2 to 10 and a temperature of 25° C.

35. The stabilizing and emulsifying agent of claim 33, wherein the molecular weight of the soy whey protein is between about 8 kDa and about 50 kDa.

36. A food product comprising the stabilizing and emulsifying agent of claim 33.
